(19) United States
(12) Patent Application Publication
(10) Pub. No.: US 2026/0013503 A1
(43) Pub. Date: Jan. 15, 2026

(54) SOLID COMPOSITION OF CYANTRANILIPROLE AND ACETAMIPRID

(71) Applicant: ADAMA MAKHTESHIM LTD., Beer Sheva (IL)

(72) Inventors: Eliz AMAR-LEWIS, Beer Sheva (IL); Yohai DAYAGI, Kibbutz Kramim (IL)

(73) Assignee: ADAMA MAKHTESHIM LTD., Beer Sheva (IL)

(21) Appl. No.: 18/996,623

(22) PCT Filed: Jul. 16, 2023
(86) PCT No.: PCT/IL2023/050742

§ 371 Date: Jan. 17, 2025

Related U.S. Application Data
(60) Provisional application No. 63/389,961, filed on Jul. 18, 2022.

(51) Int. Cl. A01N 43/56; A01N 47/40; A01P 7/04

(52) U.S. Cl. CPC A01N 43/56; A01N 47/40; A01P 7/04

(57) ABSTRACT

The present invention relates to solid water dispersible compositions comprising particulate acetamiprid and paniculate cyantraniliprole characterized by spontaneous and fast disintegration, producing physically stable suspensions of particulate cyantraniliprole in aqueous solutions of acetamiprid, with low agglomeration formation or particle size growth and minimal persistent foam. The present invention also relates to methods of use and process of preparing the solid composition comprising acetamiprid and cyantraniliprole.

Throughout this application various publications are referenced. The disclosures of these documents in their entireties are hereby incorporated by reference into this application in order to more fully describe the state of the art to which this invention pertains. In the alternative, when required, the specific identified section of the disclosures of these documents is incorporated, in those circumstances when it is inappropriate to incorporate the entire document.

### TECHNICAL FIELD

The present invention relates to pesticides exemplified by a solid composition comprising acetamiprid and cyantraniliprole. The present invention also provides methods of use and processes for preparing the compositions disclosed herein and useful parameters of the solid compositions.

### BACKGROUND

Acetamiprid, N-[(6-chloro-3-pyridyl)methyl]-N′-cyano-N-methyl-acetamidine, is a chloropyridinyl neonicotinoid, and commercial products containing acetamiprid as sole active ingredient or as part of mixture are commonly sold as soluble liquid composition (SL) composition and soluble powder (SP) compositions among others.

Cyantraniliprole, 4-Bromo-1-(3-chloropyridin-2-yl)-N-[4-cyano-2-methyl-6-(methylcarbamoyl)phenyl]-1H-pyrazole-5-carboxamide, is an anthranilamide insecticide that provides control through action on the ryanodine receptor. It activates this receptor, leading to the unregulated loss of stored calcium. This causes impaired regulation of muscle contraction. Commercial products containing cyantraniliprole as sole active ingredient or as part of mixture are also commonly sold as suspension concentrate (SC), suspoemulsion (SE) and oil dispersion (OD).

Combining the two active ingredients in a single composition with acceptable characteristics was found challenging. The challenges were fairly pronounced when attempting to combine both Acetamiprid and Cyantraniliprole into water dispersible granules with acceptable ease of dispersibility and suspensibility in water that did not produce undue foaming when dispersed in water and minimal formation of agglomerates and/or particle size growth.

Inventors note European patent application number EP14862188.1 wherein an interaction between diamide-based insecticidal-active ingredient, and a neonicotinoid-based insecticidal-active ingredient is produced. In that application the interaction between the insecticides produced in suspension is measured by changes in solid particle size. However, inventors have found that the characteristics of the suspension product of that type of interaction are unacceptable such that they at least partly define their efforts as ways to avoid formation of the product as reported in EP14862188.1, in order to produce acceptable solid compositions, which are readily dispersible or spontaneously disperse in water without undue amounts of persistent foaming, to produce stable insecticidal suspensions without the formation of agglomerates or undue particle size growth, as measured by a stable particle size distribution, in a wet sieve residue test.

Inventors similarly note the documents CN106417344; CN103283764; and CN102283205, though none of these documents recognize the challenges addressed by this invention and provide no solution to those challenges.

There is a need to develop a solid composition comprising both acetamiprid and cyantraniliprole with acceptable water dispersion characteristics of any some or notably all of, disintegration (disintegrating) rate, wettability, dispersibility including spontaneity of dispersion, and suspensibility, when diluted or dispersed in water or aqueous media, as herein below defined.

There is a need to develop a packaged solid water dispersible composition comprising both acetamiprid and cyantraniliprole in solid form which is able to maintain acceptable water dispersion characteristics of any, some, or notably all of, disintegration (disintegrating) rate, wettability, dispersibility including spontaneity of dispersion, and suspensibility, when diluted or dispersed in water or aqueous media as herein below defined, over a period of storage, maintaining a low moisture content while avoiding degradation or reduction of the pesticidally/insecticidally effective amount of active ingredients content e.g. by photodegradation and/or chemical degradation of pesticides during the period of storage and when diluted in aqueous media prior to application, or avoiding reduction of availability of the pesticidally/insecticidally effective amounts of active pesticidal ingredients content by e.g., disadvantageous polymorphic or solid-form interconversion of the active pesticidal ingredients or by deactivating interaction between acetamiprid and cyantraniliprole or interaction between either of acetamiprid and cyantraniliprole with the other composition components. A reduction of available content of active ingredients may also be a reduction of physical availability due to particle size growth or agglomerate formation.

The term deactivating interaction can include an interaction between acetamiprid and cyantraniliprole pesticidal ingredients, or interaction of each with other excipients, that results for example, in the formation of agglomerates or particle size growth, when the solid water dispersible composition is diluted or dispersed in water or aqueous media forming a suspension which is typically sieved prior to application.

Such that, although the acetamiprid and cyantraniliprole are still chemically present in the suspension, a portion of one and/or the other insecticide is in the form of agglomerates or particles with increased size, that are not physically available for pesticidal/insecticidal application due to their increased particle size and/or their precipitation or flocculation etc. such that they are no longer in suspension. Changes in particle size of cyantraniliprole (or acetamiprid) due to solid form interconversion or recrystallisation can also result in the appearance of particulates of increased and unfavorable particle size and available content reduction.

The term, physically reduced available amount or content, is perhaps a useful way to describe some aspects of the result of a deactivating interaction between acetamiprid and cyantraniliprole, by agglomerate formation or for that matter unwanted particle size growth due to the interaction (or by other processes), that result in less of the active ingredients being available for application.

There is an on-going need for a water dispersible granule or granulate comprising both cyantraniliprole and acetamiprid solid insecticide active ingredients, which is able to maintain acceptable water dispersion characteristics of any some or notably all of, disintegration (disintegrating) rate, wettability, dispersibility including spontaneity of dispersion, and suspensibility, when diluted or dispersed in water or aqueous media as herein below defined, over a period of storage, maintaining a low moisture content while avoiding chemical degradation of the active ingredients e.g. by degradation of pesticides during the period of storage or by deactivating interaction between acetamiprid and cyantraniliprole, formation of agglomerates and/or particle size growth which reduce the practical availability of a portion of the solid insecticide active ingredients when applied after dilution and/or dispersion.

### SUMMARY OF THE INVENTION

The present invention provides a solid composition comprising (1) an amount of acetamiprid, (2) an amount of cyantraniliprole and (3) agriculturally acceptable solid carrier. In some embodiments the carrier is lactose. In some embodiments the carrier is starch. In some embodiments the carrier is kaolin.

In some embodiments the present invention provides a solid composition comprising (1) an amount of acetamiprid, (2) an amount of particulate cyantraniliprole and (3) agriculturally acceptable solid carrier. In some embodiments the carrier is exemplified by lactose, starch, or kaolin.

In some embodiments the present invention provides a solid composition comprising (1) an amount of acetamiprid, (2) an amount of particulate cyantraniliprole (3) agriculturally acceptable solid carrier (4) surfactant and (5) disintegrant and/or dispersant. In some embodiments the carrier is lactose. In some embodiments the surfactant is an organo-silicone surfactant.

In some embodiments the present invention provides solid compositions comprising both particulate acetamiprid and particulate cyantraniliprole which are readily dispersible and/or disintegrable in water and aqueous media without the undue formation of foam when they are diluted or otherwise dispersed in water, and low residue when the water-diluted composition is passed through a 75 μm sieve.

In some embodiments the present invention provides solid compositions comprising both solid particulate acetamiprid and solid particulate cyantraniliprole having improved characteristics as water dispersible solid compositions, the improvements include that the solid compositions are characterized by spontaneous disintegration and/or readily dispersible with good suspensibility in aqueous media (water), low agglomerates formation in the suspensions obtained when they are dispersed or diluted in water and low persistent foam on dispersion. The solid compositions comprise acetamiprid and cyantraniliprole as solid particulates each characterized by a distinct particle size distribution (PSD), such that the D₉₀ value characterizing the acetamiprid is at least 30 microns greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the ratio between the D₉₀ values characterizing the cyantraniliprole and the acetamiprid is between 1:1.5 and 1:20 and the D₉₀ value characterizing the acetamiprid particle size distribution (PSD), is at least 50 microns greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the ratio between the D₉₀ values characterizing the cyantraniliprole and the acetamiprid is between 1:2 and 1:10 and the D₉₀ value characterizing the acetamiprid particle size distribution (PSD), is at least 50 microns greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the ratio between the D₉₀ values characterizing the cyantraniliprole and the acetamiprid is between 1:2.5 and 1:5 and the D₉₀ value characterizing the acetamiprid particle size distribution (PSD), is at least 50 microns greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the D₉₀ value characterizing the acetamiprid is about 80 microns or more and the D₉₀ value characterizing the acetamiprid is at least 30 microns greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the D₉₀ value characterizing the acetamiprid is 150 microns or more and the D₉₀ value characterizing the acetamiprid is at least 100 microns greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the D₉₀ value characterizing the acetamiprid is 200 microns or less and the D₉₀ value characterizing the acetamiprid is 150 microns or more greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the D₉₀ value characterizing the acetamiprid is 250 microns or less and the D₉₀ value characterizing the acetamiprid is 200 microns or more greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the D₉₀ value characterizing the cyantraniliprole is about 10 microns or more and the D₉₀ value characterizing the acetamiprid is 70 microns or more, greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the D₉₀ value characterizing the cyantraniliprole is 20 microns or more and the D₉₀ value characterizing the acetamiprid is 60 microns or more, greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the D₉₀ value characterizing the cyantraniliprole is 20 microns or more and the D₉₀ value characterizing the acetamiprid is 130 microns or more, greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the D90 value characterizing the cyantraniliprole is 30 microns or more and the D₉₀ value characterizing the acetamiprid is 120 microns or more, greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the D₉₀ value characterizing the cyantraniliprole is 40 microns or more and the D₉₀ value characterizing the acetamiprid is 110 microns or more, greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the In some embodiments the present invention provides solid compositions comprising both solid particulate acetamiprid and solid particulate cyantraniliprole each characterized by a distinct particle size distribution (PSD), such that the D₉₀ value characterizing the cyantraniliprole is 20 microns or more and the D₉₀ value characterizing the acetamiprid is between 130 microns and 180 microns greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the D90 value characterizing the cyantraniliprole is 30 microns or more and the D₉₀ value characterizing the acetamiprid is between 120 microns and 170 microns greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the D₉₀ value characterizing the cyantraniliprole is 40 microns or less and the D₉₀ value characterizing the acetamiprid is between 110 microns and 160 microns greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the D₉₀ value characterizing the cyantraniliprole is 45 microns or less and the D₉₀ value characterizing the acetamiprid is between 35 and 205 microns, greater than the D₉₀ value characterizing the particulate cyantraniliprole.

In some embodiments the present invention provides solid compositions comprising both solid particulate acetamiprid and solid particulate cyantraniliprole each characterized by a distinct particle size distribution (PSD), such that the D₉₀ value characterizing the cyantraniliprole is 40 microns or less and the D₉₀ value characterizing the acetamiprid is between 40 and 210 microns greater than the D₉₀ value characterizing the particulate cyantraniliprole.

Generally, in many embodiments the particulate cyantraniliprole is characterised by a particle size distribution (PSD), such that the D₉₀ value characterizing the cyantraniliprole is between about 10 microns and 45 microns, and typically between about 20 microns and about 40 microns. Additionally, in many solid composition embodiments the particulate acetamiprid is characterised by a particle size distribution (PSD), such that the D₉₀ value characterizing the acetamiprid is between about 80 microns and 250 microns, and typically between about 150 microns and about 200 microns.

In some embodiments the present invention provides compositions comprising a dispersion of particulate cyantraniliprole suspended in an aqueous solution of acetamiprid, obtained by diluting the readily dispersible and/or disintegrable solid compositions of the invention in water and/or aqueous media without the undue formation of foam characterized by low percentage residue when the water-diluted composition is passed through a 75 μm sieve.

In some embodiments the present invention provides packaged dried, solid compositions comprising both particulate acetamiprid and particulate cyantraniliprole which are characterized by a low moisture content, and a lack of measurable interaction between the acetamiprid and the cyantraniliprole during preparation and over periods of storage and shelf life. The compositions typically being granules which are readily dispersible in water and aqueous media without the undue formation of foam when they are diluted or otherwise dispersed in water.

The compositions of the invention are beneficially defined by a low percentage moisture content which is generally achieved by drying during preparation and maintained at no more than about 5% moisture content. In noted embodiments the moisture content of the composition is about 3% or less, and thus a package suitable for the compositions of the invention is selected so as to avoid significant and/or measurable increase in the moisture content of the package contents during periods of storage in humid conditions.

The package for the compositions of the invention will typically be constructed with moisture barrier materials which are sufficiently impermeable to moisture such that the solid compositions of the invention contained in the package, do not have a measurable or significant increase in moisture content over the period of storage or shelf life.

Both acetamiprid and cyantraniliprole are vulnerable to photodegradation and it is clear that rates of photodegradation are often mediated by water and that degradation of solid particulate compounds are often associated with slower rates of degradative processes than solutions.

In some embodiments the present invention thus provides packaged dried, solid compositions comprising both particulate acetamiprid and particulate cyantraniliprole which are characterized by low rate of photodegradation even if the package in which they are contained is exposed to direct UV light e.g., sunlight, over periods of storage and shelf life. The compositions typically being granules which are readily dispersible in water and aqueous media. A low rate of photodegradation is understood to be where the undegraded content of acetamiprid and/or the undegraded cyantraniliprole content in the package is no less than about 90% of the content measured prior to packaging the dried, solid compositions.

In many embodiments the particulate acetamiprid and particulate cyantraniliprole in the inventive solid compositions are each defined by different particle size distributions. In these embodiments the difference between each defining particle size distribution is typically such that they can be achieved by separately reducing the particle size of each separately, prior to their combination into a combined solid compositions comprising both particulate acetamiprid and particulate cyantraniliprole.

In some embodiments the present invention provides methods of preparing solid compositions comprising both solid particulate acetamiprid and solid particulate cyantraniliprole having improved characteristics as water dispersible solid compositions. The methods comprise incorporating the acetamiprid and cyantraniliprole into the compositions as particulates each characterized by a distinct particle size distribution (PSD). The particle size distribution of each of acetamiprid and cyantraniliprole are advantageously achieved by milling each separately from each other. In many embodiments the particle size distribution that characterizes each of acetamiprid and cyantraniliprole are such that they could not be milled together and achieve the desired PSD for each.

In some embodiments the present invention provides methods of preparing solid compositions and compositions prepared by the methods, wherein the particle size distribution of each of acetamiprid and cyantraniliprole comprising the composition are achieved by milling each separately such that the D₉₀ value characterizing the particle size distribution of particulate acetamiprid is greater than the D₉₀ value characterizing the particle size distribution of particulate cyantraniliprole, wherein the difference between the D₉₀ value for acetamiprid and cyantraniliprole is selected from the group of,
a. 30 microns or more;
b. 40 microns or more;
c. 50 microns or more;
d. 60 microns or more;
e. 70 microns or more;
f. 80 microns or more;
g. 90 microns or more;
h. 100 microns or more
i. 100 microns or more;
j. 110 microns or more;
k. 120 microns or more;
l. 130 microns or more;
m. 150 microns or more;
n. 200 microns or more;
o. between 130 and 180 microns;
p. between 120 and 170 microns;
q. between 110 and 160 microns;
r. between 35 and 205 microns; and
s. between 40 and 210 microns,
   wherein typically the value of D₉₀ for the acetamiprid particles is greater than 80 microns such as 150 microns or more, and the value of D₉₀ for the cyantraniliprole particles is typically less than 50 microns, such as about 45 microns and less. Commonly, the ratio between the D₉₀ values characterizing the cyantraniliprole PSD and the acetamiprid PSD is selected from the group of, between about 1:2 to about 1:10; between about 1:2.5 to about 1:5; and between about 1:3 to 1:4, and the D₉₀ value characterizing the cyantraniliprole particle size distribution is about 20 microns or more.

In some embodiments the present invention provides methods of preparing solid compositions comprising both solid particulate acetamiprid and solid particulate cyantraniliprole having improved characteristics as water dispersible solid compositions characterized by spontaneous disintegration and/or readily dispersible with good suspensibility in aqueous media (water), low agglomerates formation in the suspensions obtained when they are dispersed or diluted in water and low persistent foam on dispersion. The methods comprise incorporating the acetamiprid and cyantraniliprole into the compositions as particulates each characterized by a distinct particle size distribution (PSD), such that the D₉₀ value characterizing the acetamiprid is at least 30 microns greater than the D₉₀ value characterizing the particulate cyantraniliprole. In some embodiments the present invention provides methods of preparing solid water dispersible granules (WDG) comprising both solid particulate acetamiprid and solid particulate cyantraniliprole having improved characteristics. The methods comprise incorporating the acetamiprid and cyantraniliprole into the compositions as particulates each characterized by a distinct particle size distribution. The particle size distribution of each of acetamiprid and cyantraniliprole are advantageously achieved by milling each separately from each other.

In some embodiments the present invention provides methods of preparing solid water dispersible granules (WDG) comprising both solid particulate acetamiprid and solid particulate cyantraniliprole having improved characteristics. The methods comprise incorporating the acetamiprid and cyantraniliprole into the compositions as particulates each characterized by a distinct particle size distribution. The particle size distribution (PSD) of acetamiprid such that D₉₀ value is between about 80 microns to about 250 microns, usefully between about 150 microns and about 200 microns and the particle size distribution of cyantraniliprole such that D₉₀ value is between about 10 microns to about 45 microns, usefully between about 20 microns and about 40 microns.

In some embodiments the present invention provides methods of preparing solid water dispersible granules (WDG) comprising both milled solid particulate acetamiprid and milled solid particulate cyantraniliprole having improved characteristics. The methods comprise,
1. milling the acetamiprid to a particle size distribution (PSD) of acetamiprid such that D₉₀ value is between about 80 microns to about 250 microns, usefully between about 150 microns and about 200 microns,
2. separately milling the cyantraniliprole to a particle size distribution such that D₉₀ value is between about 10 microns to about 45 microns, usefully between about 20 microns and about 40 microns,
3. combining, blending, mixing etc. the separately milled acetamiprid and cyantraniliprole,
4. wet granulating the combination, blend or admix of the separately milled acetamiprid and cyantraniliprole with an aqueous solution or dispersion of organo-silicone based surfactant in water to obtain a wet granulate, and
5. drying the wet granulate to a water content of about 5% or less, usefully between about 3% and about 0.5%, and 6. Packaging the dried granules in suitable containers, packaging etc.

In some embodiments the present invention provides methods of preparing solid water dispersible granules (WDG) comprising both milled solid particulate acetamiprid and milled solid particulate cyantraniliprole having improved characteristics. The methods comprise,
1. combining, blending, mixing etc. solid particulate acetamiprid and lactose (carrier ingredient),
2. milling the combination of acetamiprid and lactose to a particle size distribution (PSD) such that D₉₀ value is between about 80 microns to about 250 microns, usefully between about 150 microns and about 200 microns,
3. separately milling the cyantraniliprole to a particle size distribution such that D₉₀ value is between about 10 microns to about 45 microns, usefully between about 20 microns and about 40 microns,
4. combining, blending, mixing etc. the separately milled acetamiprid-lactose blend, and the milled cyantraniliprole,
5. wet granulating the combination, blend or admix of the separately milled acetamiprid-lactose and cyantraniliprole with an aqueous solution or dispersion of organo-silicone based surfactant in water to obtain a wet granulate, and
6. drying the wet granulate to a water content of about 5% or less, usefully between about 3% and about 0.5%, and
7. Packaging the dried granules in suitable containers, packaging etc.

In some embodiments the present invention provides methods of preparing solid water dispersible granules (WDG) comprising both milled solid particulate acetamiprid and milled solid particulate cyantraniliprole having improved characteristics. The methods comprise,
1. combining, blending, mixing etc. solid particulate acetamiprid and lactose (carrier ingredient),
2. milling the combination, blend or admix of acetamiprid and lactose to a particle size distribution (PSD) such that D₉₀ value is between about 80 microns to about 250 microns, usefully between about 150 microns and about 200 microns,
3. combining, blending, mixing etc. solid particulate cyantraniliprole and one or more of solid dispersant and or solid wetting agent ingredients,
4. separately milling the combination, blend or admix of cyantraniliprole with dispersant and/or wetting agent to a particle size distribution such that D₉₀ value is between about 10 microns to about 45 microns, usefully between about 20 microns and about 40 microns,
5. combining, blending, mixing etc. the separately milled acetamiprid-lactose combination, and the milled cyantraniliprole-dispersant/wetting agent combination,
6. wet granulating the combination, blend or admix of the separately milled acetamiprid-lactose and cyantraniliprole-dispersant/wetting agent with an aqueous solution or dispersion of organo-silicone based surfactant in water to obtain a wet granulate, and
7. drying the wet granulate to a water content of about 5% or less, usefully between about 3% and about 0.5% to obtain dried granules, and
8. Packaging the dried granules in suitable containers, packaging etc.

In some embodiments the present invention provides methods for preventing or avoiding the interaction between acetamiprid and cyantraniliprole in suspensions of solid particulate cyantraniliprole in aqueous solutions of acetamiprid.

In some embodiments the methods comprise,
1. obtaining packaged solid water dispersible granules (WDG) comprising both solid particulate acetamiprid and solid particulate cyantraniliprole, wherein the water dispersible granules comprise
   a. a milled blend (combination mixture etc.), of particulate acetamiprid and lactose characterized by a particle size distribution (PSD) such that D₉₀ value is between about 80 microns to about 250 microns, usefully between about 150 microns and about 200 microns,
   b. a milled blend (combination mixture etc.), of solid particulate cyantraniliprole and one or more of solid dispersant and or solid wetting agent ingredients, characterized by a particle size distribution such that D₉₀ value is between about 10 microns to about 45 microns, usefully between about 20 microns and about 40 microns,
   c. organo-silicone based surfactant, and
   d. a water content of about 5% or less, usefully between about 3% and about 0.5%, in a package,
2. removing the solid water dispersible granules (WDG) from the package, and
3. diluting, contacting or dispersing the water dispersible granules in aqueous media such as water,
   to obtain a suspension of solid particulate cyantraniliprole in aqueous solution of acetamiprid characterised in that interaction between acetamiprid and cyantraniliprole is prevented, minimized or avoided, wherein the interaction can be measured by the level of agglomerates formation or particle size growth, by tests exemplified by a wet sieve retention test.

In some embodiments the present invention provides methods of minimizing preventing or avoiding agglomerating interaction between acetamiprid and cyantraniliprole in compositions containing both, the method comprising milling a blend of acetamiprid and solid carrier and separately milling cyantraniliprole prior to combining the acetamiprid and cyantraniliprole in the composition. In some embodiments, the separately milled cyantraniliprole is milled as a blend with composition ingredients selected from dispersants and wetting agents or combinations thereof.

In some embodiments the present invention provides methods of improving the quality of water dispersible granules (WDG) comprising both solid particulate acetamiprid and solid particulate cyantraniliprole wherein the improved quality comprises water dispersible granules (WDG) that are readily dispersible and/or suspensible in water to obtain stable suspensions of solid particulate cyantraniliprole in aqueous solutions of acetamiprid characterized by minimal persistent foaming and minimal or negligible agglomerates formation or particle size growth, as measured by a wet sieve retention of less than 2% by weight when the obtained suspension is passed through a sieve of 75 micron aperture,

The methods comprising
1. combining, blending, mixing etc. solid particulate acetamiprid and lactose (carrier ingredient),
2. milling the combination, blend or admix of acetamiprid and lactose to a particle size distribution (PSD) such that D₉₀ value is between about 80 microns to about 250 microns, usefully between about 150 microns and about 200 microns,
3. combining, blending, mixing etc. solid particulate cyantraniliprole and one or more of solid dispersant and or solid wetting agent ingredients,
4. separately milling the combination, blend or admix of cyantraniliprole with dispersant and/or wetting agent to a particle size distribution such that D₉₀ value is between about 10 microns to about 45 microns, usefully between about 20 microns and about 40 microns,
5. combining, blending, mixing etc. the separately milled acetamiprid-lactose combination, and the milled cyantraniliprole-dispersant/wetting agent combination,
6. wet granulating the combination, blend or admix of the separately milled acetamiprid-lactose and cyantraniliprole-dispersant/wetting agent with an aqueous solution or dispersion of organo-silicone based surfactant in water to obtain a wet granulate, and
7. drying the wet granulate to a water content of about 5% or less, usefully between about 3% and about 0.5% to obtain dried granules, and generally,
8. Packaging the dried granules in suitable containers, packaging etc.

To be clear, when particle size distribution values are discussed herein, the values such as D₉₀ are measured by bulk volume and/or weight, typically measured by a technique exemplified by a laser light diffraction scattering method, or other similar techniques well known to those skilled in these arts.

In noted embodiments the compositions of the invention are granulates characterized by a moisture content of less than about 5% w/w, and advantageously the granulates of the invention are produced by a wet granulation which is dried to a moisture content that is about 3% or less though generally not less than about 0.5%.

In addition to providing a sufficient moisture barrier as described above, a suitable package for the compositions of the invention will typically be constructed such that they provide protection from UV light within the wavelengths range of about 100-400 nm. The material of the package, container system or a coating over the package will be sufficiently opaque to UV light such that the dried, solid compositions comprising both particulate acetamiprid and particulate cyantraniliprole of the invention contained in the package, do not have a measurable or significant increases in photodegradation products over the period of storage or shelf life, even if the packaged composition is exposed to direct sunlight during storage. A measurable or significant increase is about 10% increase and advantageously about 5% or less.

In some noted embodiments the present invention provides solid composition comprising (1) solid particulate acetamiprid, (2) solid particulate cyantraniliprole and (3) agriculturally acceptable solid carrier particles.

In some embodiments, the present invention provides a solid composition comprising (1) solid particulate acetamiprid, (2) solid particulate cyantraniliprole and (3) agriculturally acceptable solid carrier, wherein in certain embodiments, the particle size distribution of the particulate acetamiprid active ingredient (AI), is different than the particle size distribution of the particulate cyantraniliprole active ingredient (AI).

In some embodiments the particle size reduction of the particulate acetamiprid AI, particulate cyantraniliprole AI, or both are performed by combining the active ingredient with a non-pesticidal composition ingredient (excipient), prior to size reduction of the blend of AI and excipient. In some embodiment the excipient for forming the blend with the AI prior to size reduction is the agriculturally acceptable solid carrier. In some embodiments the excipient is the carrier which is exemplified by lactose.

In some embodiments the reduction of the active ingredient particle size is performed by jet milling.

In some embodiments the particle size reduction of the active ingredients is by mechanical grinding or milling

In some embodiments, the present invention provides a granular composition comprising (1) solid particulate acetamiprid, (2) solid particulate cyantraniliprole and (3) agriculturally acceptable solid carrier. In many embodiments the granular composition is adapted to be dispersible in water.

In some embodiments, the present invention provides a solid composition comprising (1) an amount of acetamiprid, (2) an amount of cyantraniliprole and (3) agriculturally acceptable solid carrier wherein in several embodiments after dilution with water, the cyantraniliprole is suspended in water as solid particles and the acetamiprid is dissolved in the water.

In some embodiments, the composition is a water dispersible solid.

In some embodiments, the composition is wettable dispersible granules.

In some embodiments, the solid composition is granules.

In some embodiments, the solid composition is powder.

In some embodiments, the solid composition is tablet.

In some embodiments, the solid composition is a tablet prepared from a granulate.

In some embodiments, the present invention also provides a water dispersible solid composition comprising:
a. acetamiprid in amount of about 40% w/w such as 39.6% w/w based on the total weight of the composition, commonly about 35%-about 45%, exemplified by about 41% (41.2%) w/w and
b. cyantraniliprole in amount of about 30% w/w based on the total weight of the composition commonly about 25%-about 35%, exemplified by about 29% (28.8%) and 28% (27.7%).

In some embodiments, the present invention also provides a water dispersible solid composition comprising:
a. particulate acetamiprid,
b. particulate cyantraniliprole
c. Non-Pesticidal Ingredients (NPIs or excipients),
   wherein, the weight ratio of the acetamiprid to the cyantraniliprole in the solid composition is between 1:5 to 5:1, commonly from about 2:1 to 1:2.

In some embodiments, the solid composition is a tablet prepared from a granulate.

In some embodiments, the present invention also provides a water dispersible solid composition comprising:
a. acetamiprid in amount of about 40% w/w such as 39.6% w/w, based on the total weight of the composition, commonly from about 35% to about 45%, exemplified by about 41% (41.2%) w/w or about 40% (39.6%) and
b. cyantraniliprole in amount of about 30% w/w based on the total weight of the composition commonly from about 25% to about 35%, exemplified by about 29% (28.8%).

In some embodiments, the present invention also provides a water dispersible solid composition comprising:
a. particulate acetamiprid,
b. particulate cyantraniliprole
c. non-pesticidal Ingredients (excipients),
   wherein, the ratio the weight ratio of the acetamiprid to the cyantraniliprole in the solid composition is between 1:5 to 5:1, commonly from about 2:1 to 1:2.

In some embodiments the excipient comprises agriculturally acceptable carrier, in some embodiments the carrier is lactose, corn starch and/or kaolin.

In some embodiments the excipient comprises agriculturally acceptable wetting agent.

In some embodiments the excipient comprises agriculturally acceptable dispersant.

In some embodiments, the solid composition comprises a surfactant.

In some embodiments the composition comprises organo-silicone based surfactant.

In some embodiments, the present invention also provides a combination of water dispersible solid composition comprising
(1) particulate acetamiprid,
(2) particulate cyantraniliprole,
(3) excipients comprising,
   (i) agriculturally acceptable solid carrier and
   (ii) organo-silicone based surfactant,
and water.

In general, the terms “water-diluted” and “water-dispersed” as used herein are in no way intended to be exclusive of each other and typically a water-dispersed composition is included in the term water-diluted composition. Typically, the water-diluted compositions as herein discussed are obtained by dispersing or diluting the solid compositions of the invention with water or other aqueous media. It is clear that the use of the terms “water-diluted” or “water-dispersed” in no way suggests that the dilution or dispersion are in pure water and is understood to refer to water-based or aqueous media.

The present invention also provides a water-diluted, such as a water-dispersed, composition prepared using any one of the combination, composition or water dispersible solid composition disclosed herein, diluted and/or dispersed in an aqueous medium.

The present invention also provides a method for controlling unwanted arthropods exemplified (though not limited), herein by insects, comprising applying an effective amount of the combination, composition or suspension disclosed herein to a plant, a locus thereof, propagation material thereof, or an area infested with the unwanted insects so as to thereby control the unwanted insects.

The present invention also provides a method for controlling plant disease caused by unwanted insect comprising applying an effective amount of the combination, composition or water-diluted and/or dispersed, composition disclosed herein to a plant, a locus thereof, propagation material thereof, or an area infested with the unwanted insect so as to thereby control the plant disease caused by unwanted insect.

The present invention also provides a method for controlling unwanted insects comprising (1) obtaining a water diluted or dispersed form of the composition comprising acetamiprid and cyantraniliprole exemplified by a suspension, and (2) contacting a plant, a locus thereof, propagation material thereof, or an area infested with the unwanted insects with an effective amount of the suspension so as to thereby control the unwanted insects.

The present invention also provides a method for controlling plant disease caused by unwanted insect, comprising (1) obtaining a water diluted or dispersed form of the composition exemplified by a suspension, comprising acetamiprid and cyantraniliprole and (2) contacting a plant, a locus thereof, propagation material thereof, or an area infested with the unwanted insects with an effective amount of the suspension so as to thereby control the plant disease.

In some embodiments the present invention provides a process for preparing a water dispersible solid composition comprising acetamiprid and cyantraniliprole, the process comprising (1) preparing a pre-mix of all the solid components, (2) wetting the pre-mix of step (1) with a wetting liquid, (4) performing wet granulation and drying. The term, a pre-mix of all the solid components, refers to a premix of the solid acetamiprid, the solid cyantraniliprole and solid Non-Pesticidal Ingredients (excipients) components.

In some embodiments the present invention provides a process for preparing a packaged water dispersible solid composition in granular form, comprising acetamiprid and cyantraniliprole, the process comprising
(1) separately preparing particulate acetamiprid with a defined particle size distribution,
(2) separately preparing particulate cyantraniliprole with a different defined particle size distribution,
(3) combining the particulate acetamiprid, the particulate cyantraniliprole, and solid excipients components to obtain a pre-mix of all the solid components,
(4) wetting the obtained pre-mix of step with a wetting liquid,
(5) wet granulating, to obtain wet granules
(6) drying to obtain a dry granulate characterized by a moisture content of about 3% or less (LOD), and
(7) packaging the dry granulate into suitable containers or packages which can maintain the advantageous characteristics of the obtained dry granulate over the intended storage period or shelf life.

Typically, the suitable packaging or container system will be characterized by being sufficiently impermeable to moisture, typically being constructed from materials and closure means, that are sufficiently impermeable to the ingress of moisture such that the contained water dispersible solid composition maintains a water (moisture) content of about 5% or less over a storage period, exemplified by the shelf life of the composition or accelerated storage conditions defined by elevated temperatures and relative humidity.

Inventors envision a packaging system that improves the ease of use of a packaged water dispersible solid composition in granular form of the invention, comprising particulate acetamiprid and particulate cyantraniliprole wherein, the granular composition is packaged first in a water dispersible or water soluble material as an inner package and then the inner package is itself packed in an outer protective suitable packaging or container system characterized by being sufficiently impermeable to moisture, typically being constructed from materials and closure means, that are sufficiently impermeable to the ingress of moisture such that the inner water soluble packaging remains uncompromised and the contained water dispersible solid composition maintains a water (moisture) content of about 5% or less preferably 3% w/w or less, over a storage period, exemplified by the shelf life of the composition or accelerated storage conditions defined by elevated temperatures and relative humidity. The ease of use of the packaged water dispersible solid composition in granular form of the invention is improved by the double packaging.

The water dispersible granules packaged in the water soluble inner packaging may be removed from the outer protective packaging and introduced to water without the user having to have direct contact with the insecticidal composition contained therewithin. This type of packaging also ensures than none of the composition is spilled or otherwise lost while introducing the composition into water in a tank mix prior to application to protect an area from unwanted insects or control unwanted insects if present.

The present invention provides a process for preparing a water dispersible solid composition comprising acetamiprid and cyantraniliprole, the process comprising (1) preparing a pre-mix of all the solid components, (2) wetting the pre-mix of step (1) using a water-based wetting liquid optionally comprising organo silicon based surfactant to obtain a wetted solid composition, and (4) drying the obtained wetted solid composition.

The present invention also provides a package comprising a water dispersible solid composition comprising acetamiprid and cyantraniliprole.

In some embodiments the present invention provides a water dispersible solid composition comprising less than about 5% water, such as between 3% and 0.5% and,
1. particulate acetamiprid and particulate cyantraniliprole, wherein the particulate acetamiprid is defined by a particle size distribution, such that D₉₀ is about 80-250 microns, usefully between about 150 and about 200 microns, and/or D₉₅ is about 80-250 micron, and/or D₉₉ is between about 80-300 micron when measured by volume or weight, prior to its incorporation into the water dispersible solid composition, and
2. particulate cyantraniliprole wherein the particulate cyantraniliprole is defined by a particle size distribution, such that, D₉₀ is about 10-45 microns such as between about 20 microns and about 40 microns and/or D₉₅ is about 10-40 microns, and/or D₉₉ is between 10-50 microns when measured by volume or weight prior to its incorporation into the water dispersible solid composition and wherein
   the combined particulate ingredients of the solid composition is characterized by a particle size distribution of such that D₉₀ is about 4-200 microns.

In some embodiments the present invention provides a packaged water dispersible granular composition comprising less than about 5% water (moisture, LOD), typically less than 3% moisture though usefully 0.5% or more, and,
1. particulate acetamiprid and particulate cyantraniliprole, wherein the particulate acetamiprid is defined by a particle size distribution, such that D₉₀ is about 80-250 microns usefully between about 150 and about 200 microns, and/or D₉₅ is about 80-250 micron, and/or D₉₉ is between about 80-300 micron when measured by volume or weight, prior to its incorporation into the water dispersible solid composition, and
2. particulate cyantraniliprole wherein the particulate cyantraniliprole is defined by a particle size distribution, such that, D₉₀ is about 10-45 microns such as between about 20 microns and about 40 microns and/or D₉₅ is about 10-40 microns, and/or D₉₉ is between 10-50 microns when measured by volume or weight prior to its incorporation into the water dispersible solid composition and wherein
   the combined particulate ingredients of the solid composition is characterized by a particle size distribution such that D₉₀ is about 4-200 microns, and wherein the container system and its closure in which the granular composition is packaged is sufficiently impermeable to the ingress of water vapor, water, or moisture during storage that the moisture (water), content of the contained granulate remains less than 5% over the period of storage, typically less than about 3% moisture content, at conditions of elevated relative humidity.

In some embodiments the present invention provides a packaged water dispersible granular composition comprising less than about 5% water (moisture), typically less than 3% moisture and,
1. particulate acetamiprid, wherein the particulate acetamiprid is defined by a particle size distribution, such that D₉₀ is about 80-250 microns usefully between about 150 and about 200 microns and/or D₉₅ is about 80-250 micron, and/or D₉₉ is between about 80-300 micron when measured by volume or weight, prior to its incorporation into the water dispersible solid composition, and
2. particulate cyantraniliprole wherein the particulate cyantraniliprole is defined by a particle size distribution, such that, D₉₀ is about 10-35 microns and/or D₉₅ is about 10-40 microns, and/or D₉₉ is between 10-50 microns when measured by volume or weight prior to its incorporation into the water dispersible solid composition and wherein
   the granular composition comprises at least one of, ingredient, excipient, adjuvant, carrier or additive that can mitigate the degrading effect of exposure to UV light at 100-400 nm, exemplified by any, some or all of a UV absorber, an ingredient etc. that exhibits the absorption spectra substantially similar to that of the either acetamiprid or cyantraniliprole such as a suitable dye, colorant or pigment, an ingredient etc. capable of reducing the amount of sunlight impinging on the material, an opacifier, a reflecting pigment such as titanium dioxide and/or wherein the container system and its closure in which the granular composition is packaged is such that the acetamiprid and cyantraniliprole comprising the composition is shielded against degradation including sunlight-mediated photodegradation during transportation and/or storage; of said composition, characterized in that the container system and its closure is substantially light-resistant, notably, opaque packaging or characterized by specific properties of the material of which it is composed, including any coating applied to it, including clear and colorless or translucent container made light-resistant by means of an opaque covering or by use of secondary packaging, or within amber colored containers.

In some embodiments the present invention provides a water dispersible solid composition comprising less than about 5% water, non-pesticidal ingredients, particulate carrier, particulate acetamiprid, and particulate cyantraniliprole wherein,
1. the particulate acetamiprid is obtained by combined size reduction (e.g., co-milling), of a mixture of acetamiprid and particulate carrier exemplified by lactose, kaolin or starch, until a particle size distribution of the mixture is attained, such that D₉₀ of the size reduced mixture is from about 150μ (microns) to about 200μ (microns), usefully evaluated as from 150μ±10% to 200μ±10%, when measured by volume or weight of the mixture when size reduction is complete, and
2. particulate cyantraniliprole wherein
   a. the particulate cyantraniliprole is obtained by separately reducing the size of particulate cyantraniliprole, until a particle size distribution of cyantraniliprole is attained, such that, D₉₀ is from about 20μ (microns), to about 40μ (microns), usefully evaluated as from 20μ±10% to 40 μl±10% when measured by volume or weight prior to its incorporation into the water dispersible solid composition, or
   b. the particulate cyantraniliprole is obtained by combined size reduction (e.g., co-milling), of a mixture of cyantraniliprole and non-pesticidal particulate ingredients (excipients), other than lactose, until a particle size distribution of the mixture is attained, such that D₉₀ of the size reduced mixture is from about 20μ (microns) to about 40μ (microns), usefully evaluated as from 20μ±10% to 40μ±10%, when measured by volume or weight of the mixture when size reduction is complete,
   wherein, the size reduced acetamiprid and carrier mixture is combined with the size reduced particulate cyantraniliprole and the non-pesticidal ingredients in the water dispersible solid composition.

In some embodiments the present invention provides a packaged water dispersible granular composition comprising water, surfactant (wetting agent), non-pesticidal ingredients, particulate carrier, particulate acetamiprid, and particulate cyantraniliprole wherein,
1. the particulate acetamiprid is obtained by combined size reduction (e.g., co-milling), of a mixture of acetamiprid and particulate carrier exemplified by lactose, kaolin or starch, until a particle size distribution of the mixture is attained, such that D₉₀ of the size reduced mixture is from about 150μ (microns) to about 200μ (microns), usefully evaluated as from 150μ±10% to 200μ±10%, when measured by volume or weight of the mixture when size reduction is complete, and
2. particulate cyantraniliprole wherein
   a. the particulate cyantraniliprole is obtained by separately reducing the size of particulate cyantraniliprole, until a particle size distribution of cyantraniliprole is attained, such that, D₉₀ is from about 20μ (microns), to about 40μ (microns), usefully evaluated as from 20μμ±10% to 40μ±10% when measured by volume or weight prior to its incorporation into the water dispersible solid composition, or
   b. the particulate cyantraniliprole is obtained by a separate combined size reduction (e.g., co-milling) process, of a mixture of cyantraniliprole and non-pesticidal particulate ingredients (excipients), other than lactose, until a particle size distribution of the mixture is attained, such that D₉₀ of the size reduced mixture is from about 20μ (microns) to about 40μ (microns), usefully evaluated as from 20μ±10% to 40μ±10%, when measured by volume or weight of the mixture when size reduction is complete.
   wherein, the size reduced acetamiprid and carrier mixture is combined with the size reduced particulate cyantraniliprole and the non-pesticidal ingredients and granulated with water and surfactant and dried to form a water dispersible granular composition comprising less than about 5% water, typically less than 3% moisture,
      wherein the container system and its closure in which the granular composition is packaged is sufficiently impermeable to the ingress of water vapor, water, or moisture during storage that the moisture (water), content of the contained granulate remains less than 5% over the period of storage, typically less than about 3% moisture content, at conditions of elevated relative humidity.

In some embodiments the present invention provides a packaged water dispersible granular composition comprising water, surfactant (wetting agent), non-pesticidal ingredients, particulate carrier, particulate acetamiprid, and particulate cyantraniliprole wherein,
1. the particulate acetamiprid is obtained by combined size reduction (e.g., co-milling), of a mixture of acetamiprid and particulate carrier exemplified by lactose, kaolin or starch, until a particle size distribution of the mixture is attained, such that D₉₀ of the size reduced mixture is from about 150μ (microns) to about 200μ (microns), usefully evaluated as from 150μ±10% to 200μ±10%, when measured by volume or weight of the mixture when size reduction is complete, and
2. particulate cyantraniliprole wherein
   a. the particulate cyantraniliprole is obtained by separately reducing the size of particulate cyantraniliprole, until a particle size distribution of cyantraniliprole is attained, such that, D₉₀ is from about 20μ (microns), to about 40μ (microns), usefully evaluated as from 20μμ±10% to 40μ±10% when measured by volume or weight prior to its incorporation into the water dispersible solid composition, or
   b. the particulate cyantraniliprole is obtained by a separate combined size reduction (e.g., co-milling) process, of a mixture of cyantraniliprole and non-pesticidal particulate ingredients (excipients), other than lactose, until a particle size distribution of the mixture is attained, such that D₉₀ of the size reduced mixture is from about 20μ (microns) to about 40μ (microns), usefully evaluated as from 20μ±10% to 40μ±10%, when measured by volume or weight of the mixture when size reduction is complete.
      wherein, the size reduced acetamiprid and carrier mixture is combined with the size reduced particulate cyantraniliprole and the non-pesticidal ingredients and granulated with water and surfactant and dried to form a water dispersible granular composition comprising less than about 5% water, typically less than 3% moisture, and wherein
      the non-pesticidal ingredients comprise at least one of, ingredient, excipient, adjuvant, carrier or additive that can mitigate the degrading effect of exposure of the packaged water dispersible granular composition to UV light at 100-400 nm, exemplified by any, some or all of a UV absorber, an ingredient etc. that exhibits the absorption spectra substantially similar to that of the either acetamiprid or cyantraniliprole such as a suitable dye, colorant or pigment, an ingredient etc. capable of reducing the amount of sunlight impinging on the material, an opacifier, a reflecting pigment such as titanium dioxide and/or wherein the container system and its closure in which the granular composition is packaged is such that the acetamiprid and cyantraniliprole comprising the composition is shielded against degradation including sunlight-mediated photodegradation during transportation and/or storage; of said composition, characterized in that the container system and its closure is substantially light-resistant, notably, opaque packaging or characterized by specific properties of the material of which it is composed, including any coating applied to it, including clear and colorless or translucent container made light-resistant by means of an opaque covering or by use of secondary packaging, or within amber colored containers.

In notable embodiments the water dispersible granular composition of the invention are packaged in containers, wherein the container system and its closure in which the granular composition is packaged is both,
a. sufficiently impermeable to the ingress of water vapor, water, or moisture during storage that the moisture (water), content of the contained granulate remains less than 5% over the period of storage, typically less than about 3% moisture content, at conditions of elevated relative humidity, and
b. substantially light-resistant, notably, opaque packaging or characterized by specific properties of the material of which it is composed, including any coating applied to it, including clear and colorless or translucent container made light-resistant by means of an opaque covering or by use of secondary packaging, or within amber colored containers that can mitigate the degrading effect of exposure of the packaged water dispersible granular composition to UV light at 100-400 nm.

### DETAILED DESCRIPTION OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter belongs.

In general, the terms “water-diluted” and “water-dispersed” as used herein are in no way intended to be exclusive of each other and typically a water-dispersed composition is included in the term water-diluted composition. Typically, the water-diluted compositions as herein discussed are obtained by dispersing or diluting the solid compositions of the invention with water or other aqueous media. It is clear that the use of the terms “water-diluted” or “water-dispersed” in no way suggests that the dilution or dispersion are always in pure water and is understood to refer to water-based or aqueous media.

While both dispersions of solids in liquids and dispersible granulates (or powders, tablets etc.), are often included in the term “solid compositions”, generally, this disclosure will refer to granules and powders etc., as solid compositions and the dispersions and suspensions that result from contacting these solids with aqueous media (water), are addressed as compositions obtainable therefrom. However as is demonstrated, the characteristics of the dispersions and suspensions that result from contacting or diluting the solid compositions of the invention with aqueous media (water) are directly affected by the characteristics of the inventive water dispersible solid compositions disclosed and are thus an integral part of the invention.

As used herein, the term “tank mix” means at least two of the components of the combination and/or water diluted composition of the present invention are mixed in a tank.

As used herein, the term “effective amount” refers to an amount of the acetamiprid and cyantraniliprole (active ingredient (AI)), which when ingested, contacted with or sensed, is sufficient to achieve a good level of control.

As used herein, an “agriculturally acceptable solid carrier” is a compound that is known and accepted in the art for use in the formation of solid compositions for agricultural or horticultural use.

As used herein, the term “adjuvant” is defined as any substance that is not an active ingredient but which enhances or is intended to enhance the effectiveness of the active ingredient, for example pesticide, with which it is used. Adjuvants may include, but are not limited to, spreading agents, penetrants, compatibility agents, and drift retardants.

As used herein, the term “tank sprayer” means the tank where the composition is added to water before use, at the time of spray application.

As used herein, the term “plant” includes reference to the whole plant, plant organ (e.g., leaves, stems, twigs, roots, trunks, limbs, shoots, fruits etc.), or plant cells.

As used herein, the term “plant” includes reference to agricultural crops including field crops (soybean, maize, wheat, rice, etc.), vegetable crops (potatoes, cabbages, etc.) and fruits (peach, etc.).

As used herein, the term “propagation material” is to be understood to denote all the generative parts of the plant such as seeds and spores, vegetative structures such as bulbs, corms, tubers, rhizomes, roots stems, basal shoots, stolons and buds.

As used herein, the term “locus” includes not only areas where insect may already exist, but also areas where insect has yet to emerge, and also to areas under cultivation.

As used herein the term “knockdown treatment” or “knockdown activity” means an application of one or more insecticide for controlling insect infestation of the plant or locus before and/or after an infestation or before and/or after insect damage are shown and/or when the pest pressure is low/high. Insect pressure may be assessed based on the conditions associated with insect development such as population density and certain environmental conditions.

As used herein the term “persistence treatment” or “persistence activity” is used in connection with an insecticide, the term means an application of one or more insecticide for controlling insect infestation of the plant or locus over an extended period of time, before and/or after an infestation or before and/or after insect damage are shown and/or when the insect pressure is low/high. Insect pressure may be assessed based on the conditions associated with insect development such as population density and certain environmental conditions.

As used herein, the term “ha” refers to hectare.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of.”

Unless the context or text dictates otherwise, all numbers or numerical values are to be considered as preceded by the term “about” unless the numerical value or limit will lose its clarity, such as a limiting value such as, no more than or less than. The term “about” as used herein specifically includes ±10% from the indicated values in the range. In addition, the endpoints of all ranges directed to the same component or property herein are inclusive of the endpoints, are independently combinable, and include all intermediate points and ranges using generally accepted rounding methods. It is understood that where a parameter range is provided, all integers within that range, and tenths thereof, are also provided by the invention. For example, “10-50%” includes 9.5%, 9.6%, 9.7%, 9.8%, 9.9%, 10%, 10.1%, 10.2%, etc. up to 50.4%.

In some embodiments, “water dispersible solid composition” refers to a solid composition comprising two or more components formulated to disperse at least one component of the composition in the form of solid particles when mixed with water.

In some embodiments, at least one of the components dispersed in the form of solid particles is the active ingredient.

Formulating acetamiprid and cyantraniliprole as a ready mixture composition is challenging.

It was found that formulating the acetamiprid and cyantraniliprole in the form of a solid composition provides a chemical and physical stable product for preparing a ready mix composition.

A typical solid composition that is useful is in the form of water-dispersible granules, often comprising particulate acetamiprid and particulate cyantraniliprole, adapted to be easily dispersed in aqueous systems with little foaming and high suspensibility.

It was also found that the stability and properties of solid composition comprising cyantraniliprole and acetamiprid may be improved by controlling different parameters. Particle size of the acetamiprid and cyantraniliprole, granulation condition such as amount of granulation aid agent (e.g., water during granulation process) and/or using specific wetting agent which may affect the physical properties (such as wettability and suspensibility) of the composition prior and after storage.

It was also found that acetamiprid and cyantraniliprole can be formulated as a water dispersible solid composition which disintegrates and disperses rapidly in water wherein the cyantraniliprole disperses in water in solid form and acetamiprid is dissolved in the water.

It was found that the following acceptable parameters characterizing the water-dispersible granular embodiments of the invention by the qualities achieved when it is diluted in water or aqueous media can be articulated as, any some or all of,
a) disintegration that does not require more than 25 inversions to be complete when measured as detailed below by repeatedly inverting a cylinder containing water and a sample of the composition until complete disintegration is observed,
b) less than 2% agglomerates formed on dilution when tested by a method such as a wet sieve residue (WSR) test result, that does not exceed 2% by weight of the granules when passed through a 75 micron screen, and/or
c) a level of persistent foaming after dilution that does not exceed 59 ml when the composition is dispersed in water at a concentration of 0.5% by weight in 100 ml water D (according to CIPAC)) after 1 min.

The test for the amount of wet sieve residue when the diluted solid water dispersible granule composition is passed through a 75 micron screen after disintegration of the composition in water (dilution), is significant.

The significance of this test to the solid water dispersible compositions of this invention is that this test is an indicator of the amount of unwanted formation of agglomerates in the diluted liquid that results from dispersing the solid composition in water (aqueous media). This is because the screen chosen for this test has apertures that are significantly larger than the particulate cyantraniliprole and solid additives in the composition and particulate acetamiprid (and lactose) is soluble in water, thus the only residue that remains on the sieve should be the unwanted agglomerates that have formed rather than any primary particles of ingredients included in the water dispersible solid composition, exemplified by water dispersible granules. The limits for acceptable diluted water dispersible granule composition can be alternatively estimated as less than about 2% w/w agglomerates as a percentage of all non-water ingredients in the diluted liquid.

Stable solid composition comprising cyantraniliprole and acetamiprid, as well as their methods of use and processes of preparation, are described below.

### Composition of Acetamiprid and Cyantraniliprole

The present invention provides a solid composition comprising (1) an amount of particulate acetamiprid, (2) an amount of particulate cyantraniliprole and (3) agriculturally acceptable solid carrier, wherein the particulate acetamiprid and cyantraniliprole are each characterized by a distinct particle size distribution.

The present invention provides a solid composition comprising (1) an amount of acetamiprid, (2) an amount of cyantraniliprole and (3) agriculturally acceptable solid carrier wherein after dilution with water, the cyantraniliprole is suspended in water as solid particles and the acetamiprid is dissolved in the water.

In some embodiments, the composition is a water dispersible solid.

In some embodiments, the composition is wettable dispersible granules.

In some embodiments, the solid composition is granules.

In some embodiments, the solid composition is powder.

In some embodiments, the solid composition is tablet.

In some embodiments, the present invention also provides a water dispersible solid composition comprising:
a. acetamiprid in amount of about 40% (41.2%) w/w based on the total weight of the composition and
b. cyantraniliprole in amount of about 30% (28.8%) w/w based on the total weight of the composition.

In some embodiments, the present invention also provides a water dispersible solid composition comprising:
a. particulate acetamiprid in amount of about 40% (41.2%) w/w based on the total weight of the composition characterized by a particle size distribution such that D₉₀ is between 80 and 250 microns, usefully, between about 150μ to about 200μ,
b. particulate cyantraniliprole in amount of about 30% (28.8%) w/w based on the total weight of the composition characterized by a particle size distribution such that D₉₀ is between 10 and 45 microns, usefully between about 20μ and about 40μ,
c. agriculturally acceptable non-pesticidal ingredients, comprising particulate carrier and surfactant.

In some embodiments of the invention the composition is water-dispersible granules obtainable by wet granulating the particulate acetamiprid, the particulate cyantraniliprole and the particulate carrier with an aqueous solution of the surfactant (granulation liquid), and then typically dried to a water content of about 3% w/w or less, though usefully not less than about 0.5% moisture and often then packaged. In some noted embodiments the surfactant is an organo-silicone (organo-silicon-based), surfactant and/or the granulating liquid is a solution or dispersion of organo-silicone-based surfactant.

In some embodiments, the present invention also provides packaged water dispersible solid composition comprising:
a. particulate acetamiprid in amount of about 40% (41.2%) w/w based on the total weight of the composition characterized by a particle size distribution such that D₉₀ is between 80 and 250 microns, usefully, between about 150μ to about 200μ,
b. particulate cyantraniliprole in amount of about 30% (28.8%) w/w based on the total weight of the composition characterized by a particle size distribution such that D₉₀ is between 10 and 45 microns, usefully between about 20μ and about 40μ,
c. agriculturally acceptable non-pesticidal ingredients, particulate carrier and surfactant,
d. 5% water or less,
   wherein the composition is water-dispersible granules maintained at a moisture content not exceeding 5% over a period of storage by the packaging container.

In some embodiments of the invention the water-dispersible granules are obtainable by size reducing the particulate acetamiprid together with the particulate carrier exemplified by lactose, the particulate cyantraniliprole is separately size reduced optionally together with the non-pesticidal ingredients other than lactose, wet granulating the particulate acetamiprid, the particulate cyantraniliprole, the non-pesticidal ingredients and the particulate carrier with an aqueous solution of the surfactant, and then typically drying to a water content of about 3% w/w or less, though usefully not less than 0.5% moisture, and often then packaged.

In some embodiments, the present invention also water dispersible solid composition comprising:
a. particulate acetamiprid in amount of about 35-45% (e.g., 41%) w/w based on the total weight of the composition characterized by a particle size distribution such that D₉₀ is between 150μ±10% and 200μ±10%, and
b. particulate cyantraniliprole in amount of about 25-35% (e.g., 29%) w/w based on the total weight of the composition characterized by a particle size distribution such that D₉₀ is between 20μ±10% and 40μ±10%,
c. agriculturally acceptable non-pesticidal ingredients, particulate carrier and wetting agent and
d. about 3% water (Moisture, LOD) or less,
   wherein the composition is water-dispersible granules.

In some embodiments, the present invention also provides packaged water dispersible solid composition comprising:
a. particulate acetamiprid characterized by a particle size distribution such that D₉₀ is between about 150 microns and about 200 microns, and
b. particulate cyantraniliprole characterized by a particle size distribution such that D₉₀ is between about 20 microns and about 40 microns,
c. agriculturally acceptable non-pesticidal ingredients, particulate carrier and surfactant and
d. about 3% water or less,
   wherein the weight ratio of particulate acetamiprid to particulate cyantraniliprole in the composition is between 1:5 to 5:1, commonly from about 2:1 to about 1:2 and the composition is in the form of dried water-dispersible granules.

In some embodiments, the present invention also provides a water dispersible solid composition comprising:
a. acetamiprid in amount of about 35-45% (˜40%) w/w based on the total weight of the composition
b. cyantraniliprole in amount of about 25-35% (˜30%%) w/w based on the total weight of the composition and
e. dispersing agent, in amount of about 5% to about 15% (e.g., about 10%) w/w based on the total weight of the composition, selected from hydrophobically modified polyacrylate such as modified styrene acrylic polymer, a copolymer of AMPS and ethyl acrylate, alkyl naphthalene sulfonate formaldehyde condensate, or polycarboxylate such as di-iso butylene maleic acid co-polymer, sodium salt, lignosulfonates and combinations thereof,
   characterised in that each of the acetamiprid and cyantraniliprole are in solid particulate form and wherein each of acetamiprid and cyantraniliprole is defined by a particle size distribution that is different and/or distinguished, such that either a size reduction procedure would require separately reducing the particle size of each prior to their incorporation into the solid composition or that each of acetamiprid and cyantraniliprole was obtained separately at the characteristic particle size distribution.

In some embodiments, the present invention also provides packaged water dispersible solid composition comprising:
e. an admixture of particulate acetamiprid and particulate carrier characterized by a combined particle size distribution such that D₉₀ is between about 150 microns and about 200 microns, and
f. particulate cyantraniliprole characterized by a particle size distribution such that D₉₀ is between about 20 microns and about 40 microns,
g. agriculturally acceptable non-pesticidal ingredients, and surfactant and
h. about 3% water or less,
   wherein the weight ratio of particulate acetamiprid to particulate cyantraniliprole in the composition is between 1:5 to 5:1, commonly from about 2:1 to about 1:2 and the composition is in the form of dried water-dispersible granules.

In some embodiments, the present invention also provides a water dispersible solid composition comprising:
a. particulate acetamiprid in amount of about 35-45% (˜40%) w/w based on the total weight of the composition
b. particulate cyantraniliprole in amount of about 25-35% (˜30%%) w/w based on the total weight of the composition, and
c. dispersing agent, in amount of about 5-15% (e.g., 10%) w/w based on the total weight of the composition, wherein the dispersing agent is selected from hydrophobically modified polyacrylate (such as modified styrene acrylic polymer), copolymer of AMPS and ethyl acrylate, alkyl naphthalene sulfonate formaldehyde condensate, or polycarboxylate (such as di-iso butylene maleic acid co-polymer, sodium salt), lignosulfonates and combinations thereof,
   characterised in that each of the particulate acetamiprid and particulate cyantraniliprole are defined by a particle size distribution that is different and/or distinguished, such that either a size reduction procedure would require separately reducing the particle size of each prior to their incorporation into the solid composition or that each of acetamiprid and cyantraniliprole was obtained separately at the characteristic particle size distribution. In typical embodiments of the present invention the particulate acetamiprid is obtained by size reducing a mixture, combination or blend, of acetamiprid and lactose or other carrier, and the particulate cyantraniliprole is obtained by separately size reducing cyantraniliprole optionally in admixture, combination or blended with the dispersing agent.

In some embodiments, the present invention also provides a water dispersible solid composition comprising:
a. acetamiprid in amount of about 35-45% w/w based on the total weight of the composition,
b. cyantraniliprole in amount of about 25-35% w/w based on the total weight of the composition.

In some embodiments, the present invention also provides a water dispersible solid composition comprising:
a. acetamiprid in amount of about 35-45% w/w based on the total weight of the composition,
b. cyantraniliprole in amount of about 25-35% w/w based on the total weight of the composition.
c. dispersant, in amount of up to about 10% w/w based on the total weight of the composition, wherein the surfactant is selected from hydrophobically modified polyacrylate (such as modified styrene acrylic polymer,), AMPS-ethyl acrylate co-polymer, alkyl naphthalene sulfonate formaldehyde condensate, or polycarboxylate (such as di-iso butylene maleic acid co-polymer, sodium salt), lignosulfonates and any combination thereof.

In some embodiments, the solid composition further comprising water up to about 3% w/w based on the total weight of the composition. In some embodiments the solid composition is a wet granulated composition dried to a loss on dry value of 3% w/w water content.

In some embodiments, the present invention also provides a water dispersible granules composition, comprising acetamiprid and cyantraniliprole that possess agriculturally appropriate wetting, dispersibility and dispersion stability. Parameters and testing protocols are herein defined within this disclosure and in accepted industry specifications for agricultural water-dispersible solid compositions.

The water dispersible granules composition of the present invention exhibits acceptable dispersion stability as defined herein with no appreciable agglomeration of particles beyond the specified test parameters herein defined.

The ready-mix water dispersible solid compositions of the present invention undergo spontaneous dispersion when mixed with water in a tank sprayer before application to the plant exemplified by requiring 25 inversions or less to disintegrate when tested in an inverting cylinder of water comprising the solid composition.

The water-dispersible or wettable granule embodiments of the invention are advantageously characterized with limited persistent foaming as herein defined after dilution in water or aqueous media. Such that persistent foaming when the granule is diluted 0.5% in water D (according to CIPAC)) after 1 min—should not exceed 59 ml.

As used herein, the term “water dispersible granules composition” is not to be considered as being in any real way different than the term “wettable dispersible granules composition.” The present invention provides wettable dispersible solid composition comprising an amount of particulate cyantraniliprole and an amount of particulate acetamiprid. In many embodiments the particulate acetamiprid comprises an admixture, combination and or blend of acetamiprid and lactose co-milled to a defined particle size separately from cyantraniliprole.

In some embodiments the particulate cyantraniliprole comprises an admixture, combination and or blend of cyantraniliprole and dispersant co-milled to a defined particle size separately from the particulate acetamiprid.

In some embodiments, particle size affects the physical stability, dispersion quality of the acetamiprid and cyantraniliprole.

In some embodiments, the particle size distribution of the acetamiprid and the cyantraniliprole are different and this improves the physical stability and dispersion quality of the composition comprising both particulate acetamiprid and particulate cyantraniliprole when the composition is dispersed in water.

In some embodiments the particle size distribution of the particulate acetamiprid is so different from the particle size distribution of the particulate cyantraniliprole such that for all practical purposes the process of obtaining particulate acetamiprid by size reduction must be conducted separately from the size reduction process required for obtaining the particulate cyantraniliprole.

In some noted embodiments particulate acetamiprid is mixed, combined and/or blended with lactose or other carrier material prior to being co-milled (size reduced), to obtain a particle size distribution characterized such that the D₉₀ value lies between about 150 microns and about 200 microns.

In some embodiments wherein the composition of the invention comprises lactose, the lactose is advantageously milled prior to incorporation in the composition and not introduced as-is. The quality of the aqueous dispersion or dilution of the composition of the invention comprising lactose in water is improved when the lactose has been size reduced to blow 300 microns, especially as regards parameters of foaming and percentage of material that remains when sieved through a 75 micron sieve.

Thus, there are advantages achieved by co-milling acetamiprid and lactose together to a particle size distribution such that D90 is between about 150 microns to about 200 microns prior to being combined with particulate cyantraniliprole characterised by a particle size distribution such that D90 is between about 20 microns and about 40 microns.

In several embodiments the cyantraniliprole is beneficially co-milled with the dispersant exemplified by lignosulphonate (e.g., Borresperse calcium or sodium) and/or Modified styrene acrylic polymer modified styrene acrylic polymer (e.g., Atlox® Metasperse 550)

In some embodiments, the weight ratio of the acetamiprid to the cyantraniliprole in the solid composition is between 1:5 to 5:1. In some embodiments, the weight ratio of the acetamiprid to the cyantraniliprole in the solid composition is 1.43:1.

In some embodiments, the amount of acetamiprid in the composition is between about 1% to about 90% w/w based on the total weight of the composition. In some embodiments, the amount of acetamiprid in the composition is between about 10% to about 80% w/w based on the total weight of the composition. In some embodiments, the amount of acetamiprid in the composition is between about 20% to about 80% w/w based on the total weight of the composition. In some embodiments, the amount of acetamiprid in the composition is between about 35% to about 45% w/w based on the total weight of the composition. In some embodiments, the amount of acetamiprid in the composition is about 41% (41.2%) w/w based on the total weight of the composition.

In some embodiments, the amount of cyantraniliprole in the composition is between about 1% to about 90% w/w based on the total weight of the composition. In some embodiments, the amount of cyantraniliprole in the composition is between about 10% to about 80% w/w based on the total weight of the composition. In some embodiments, the amount of cyantraniliprole in the composition is between about 20% to about 80% w/w based on the total weight of the composition. In some embodiments, the amount of cyantraniliprole in the composition is between about 25% to about 35% w/w based on the total weight of the composition. In some embodiments, the amount of cyantraniliprole in the composition is about 29% (28.8%) w/w based on the total weight of the composition.

In some embodiments, the composition comprises solid particles which have a particle size distribution of 4-200 microns. In some embodiments, the solid particles of acetamiprid have a particle size distribution D₉₀ of 80-200 microns, usefully between about 150 microns to about 200 microns. In some embodiments, the solid particles of acetamiprid have a particle size distribution D₉₅ of 80-250 micron. In some embodiments, the solid particles of acetamiprid have a particle size distribution D₉₉ of between 80-300 micron.

In some embodiments, the solid particles of cyantraniliprole have a particle size distribution (PSD) with a D₉₀ value of 10-45 microns, advantageously between about 20 to about 40 microns.

In some embodiments, the solid particles of cyantraniliprole have a particle size distribution D95 of 10-40 micron. In some embodiments, the solid particles of cyantraniliprole have a particle size distribution D99 of between 10-50 microns.

In some embodiments, the particle size of the agriculturally acceptable solid additive is less than 30 microns (D90). In some embodiments, the particle size of the agriculturally acceptable solid additive is less than 25 microns (D90). In some embodiments, the particle size of the agriculturally acceptable solid additive is less than 20 micron (D90). In some embodiments, the particle size of the filler and/or binder is less than 20 micron (D90). However, it was found that there is an advantage to be gained if lactose (if present), is characterized by a particle size distribution of between 80 and 250 microns conveniently obtained by co-milling acetamiprid and lactose together to a combined particle size distribution characterized by a D90 value of between about 150 microns and about 200 microns.

The composition may comprise any component used to formulate the water dispersible solid composition. In some embodiments, the solid composition is mixed with organo-silicone based surfactant as tank mix and/or ready mix.

In some embodiments the water dispersible solid composition is a wet granulated blend of particulate acetamiprid and particulate cyantraniliprole wherein the particulate acetamiprid and particulate cyantraniliprole are wetted and granulated with a combination of water and organo-silicone surfactant.

In some embodiments, the inventive solid dispersible pesticidal (insecticidal), compositions maintain their advantages (stable), as detailed herein over a period of storage selected from, the solid composition is stored for a period between 2 weeks and 6 months prior to application; In some embodiments, the solid composition is stored for 2 weeks prior to application. In some embodiments, the solid composition is stored for 1 month prior to application. In some embodiments, the solid composition is stored for 2 months prior to application. In some embodiments, the solid composition is stored for 3 months prior to application. In some embodiments, the solid composition is stored for 6 months prior to application. In some noted embodiments the compositions of the invention maintain their advantages, over the entire shelf-life of the composition being not less than a year prior to application.

In some embodiments the inventive solid dispersible pesticidal (insecticidal), compositions are packaged water dispersible granules that are stable, characterized in that the specified physical and chemical parameters and attributes and advantages as herein detailed, are maintained over periods of storage at ambient temperatures selected from periods between about 6 months and 5 years, wherein the container within which they are packaged, is suitable for storage of the water dispersible granules as herein disclosed, both as regards impermeability to moisture (moisture barrier) and protection from UV light (sunlight).

The compositions of the invention maintain the physical and chemical advantages as herein disclosed when stored at controlled or uncontrolled temperatures between about −20° C. to about +54° C. In some embodiments, the solid composition is stored at a temperature between −15° C. to 54° C. In some embodiments, the solid composition is stored at a temperature between −15° C. to 0° C. In some embodiments, the solid composition is stored at a temperature between 0° C. to 10° C. In some embodiments, the solid composition is stored at a temperature between 10° C. to 20° C. In some embodiments, the solid composition is stored at a temperature between 20° C. to 25° C. In some embodiments, the solid composition is stored at a temperature between 25° C. to 54° C.

In some embodiments, the solid composition is stable. In some embodiments, the solid composition is chemically stable. In some embodiments, the solid composition is physically stable. In some embodiments, the solid composition is stable after storage, including storage for the durations described above at temperatures described above.

In notable embodiments the inventive compositions are water dispersible granules which are characterized by being readily dispersible and/or disintegrable such as the number of inversions of a water filled cylinder comprising the granules does not exceed 25.

In notable embodiments the inventive compositions are water dispersible granules which are characterized by producing a dispersion when contacted with water such that when the dispersion is passed through a 75μ aperture wet sieve, the residue does not exceed 2% of the wight of the solid originally comprising the composition.

In notable embodiments the inventive compositions are water dispersible granules which are characterized by displaying a maximum persistent foaming after 1 min when diluted 0.5% in 100 ml water (0.5%) not exceeding 59 ml.

In notable embodiments the inventive compositions are packaged water dispersible granules which are characterized by a chemical stability such that the percentage content of undegraded acetamiprid is no less than about 90% w/w after periods of storage as detailed above, as compared to the acetamiprid content measured at the time the granules were prepared and/or packaged.

In notable embodiments the inventive compositions are packaged water dispersible granules which are characterized by a chemical stability such that the percentage content of undegraded cyantraniliprole is no less than about 90% w/w after periods of storage and temperature as detailed above, as compared to the cyantraniliprole content measured at the time the granules were prepared and/or packaged.

In notable embodiments the inventive compositions are packaged water dispersible granules which are characterized by a lack of deactivating interaction between cyantraniliprole and acetamiprid during the steps of combination, blending, granulation, drying, packaging and over the periods of storage and temperatures exemplified above.

In some embodiments the inventive compositions are water dispersible granules (WDG) comprising particulate acetamiprid with a particle size distribution (PSD) characterized by a D₉₀ value between about 150 and about 200 microns and particulate cyantraniliprole with a particle size distribution (PSD) characterized by a D₉₀ value between about 20 microns and about 40 microns.

In some embodiments the water dispersible granules of the invention are characterized by any, some, or all, selected from,
A. being readily disintegrable in aqueous media, measured by a disintegration test such as a test wherein the number of inversions of a 250 ml cylinder comprising 2.5 g granules and 100 ml water required for all granules to be disintegrated and the remaining solid material completely suspended does not exceed 25;
B. Good dispersibility, wherein the granules display a value of greater than 60%. dispersibility when tested according to CIPAC MT 174 wherein 9 g granules is added to 900 gr water under agitation at 300 RPM for 1 minute as detailed herein below;
C. Suspensibility of between greater than 60% and less than 105% when tested according to CIPAC MT184 method, where 0.075 gr of the water dispersible solid composition is added to a cylinder containing 250 ml water (342 ppm salinity), and dispersed by shaking as detailed herein below;
D. producing a dispersion characterized by low content of agglomerates when contacted with water such that when the dispersion is passed through a 75μ aperture wet sieve, the residue does not exceed 2% of the wight of the solid originally comprising the composition (Wet Sieve Retention);
E. displaying a maximum persistent foaming after 1 min when diluted 0.5% in 100 ml water (0.5%) not exceeding 59 ml;
F. a chemical stability when packaged such that the percentage content of undegraded acetamiprid is no less than about 90% w/w after periods of storage as detailed herein, such as 2 weeks at 54° C. and/or the period of product shelf life at ambient conditions, as compared to the acetamiprid content measured at the time the granules were prepared and/or packaged;
G. a chemical stability when packaged such that the percentage content of undegraded cyantraniliprole is no less than about 90% w/w after periods of storage and temperature as detailed above, as compared to the cyantraniliprole content measured at the time the granules were prepared and/or packaged; and
H. a lack of deactivating interaction between cyantraniliprole and acetamiprid during the steps of combination, blending, granulation, drying, packaging and over the periods of storage and temperatures exemplified above.

When mixed with water or aqueous media, the components of the water dispersible solid composition disperse in the water (or aqueous media), to form solid particles having small particle sizes in suspension.

When mixed with water or aqueous media, the components of the water dispersible solid composition of the invention, disperse in the water (or aqueous media), to form a suspension of solid particles characterized by a particle size distribution such that the D₉₈ value is about 75 microns or less as measured by a wet screen retention test through a 75 micron sieve.

In some embodiments, mixing with water refers to adding water to the composition.

In some embodiments, mixing with water refers to adding the composition into the water.

In some embodiment, the solid composition is a powder composition.

In some embodiment, the solid composition is a granular composition.

In some embodiments, the composition comprises organo-silicone based surfactant.

In some embodiments the compositions comprise two surfactants (wetting agents) one of which is an organo-silicone surfactant.

When the composition further comprises organo-silicone based surfactant, for example as ready mix, the weight ratio between the cyantraniliprole and the organo-silicone based surfactant in the composition is between about 200:1 to about 20:1.

In some embodiments, the present invention provides a combination of,
(i) water dispersible solid composition comprising
   (1) particulate acetamiprid,
   (2) particulate cyantraniliprole,
   (3) particulate agriculturally acceptable solid carrier, such as lactose, starch, or kaolin, and
(ii) an amount of a surfactant.

In some embodiments, the present invention provides a combination of,
(i) water dispersible solid composition comprising
   (1) particulate acetamiprid,
   (2) particulate cyantraniliprole,
   (3) particulate agriculturally acceptable solid carrier,
(ii) a surfactant, and
(iii) a dispersant.

In some embodiments, the present invention provides a combination of,
(i) water dispersible solid composition comprising
   (1) an amount of acetamiprid,
   (2) an amount of cyantraniliprole,
   (3) agriculturally acceptable solid carrier and
(ii) an amount of organo-silicone based surfactant.

In some embodiments, the present invention provides a combination of,
(i) water dispersible solid composition comprising
   (1) particulate acetamiprid,
   (2) particulate cyantraniliprole,
   (3) agriculturally acceptable solid carrier such as lactose, starch, or kaolin, and
(ii) organo-silicone based surfactant.

In some embodiments, the composition is adapted to be combined with organo-silicone based surfactant in tank mix (in presence of water). The adaptation can be by combining the composition with instructions to combine the composition with organo-silicone based surfactant in tank mix, or by packaging the composition in a kit together with the organo-silicone based surfactant, or any such similar adaptation.

When the composition is combined with organo-silicone based surfactant as tank mix, the weight ratio between the cyantraniliprole and the organo-silicone based surfactant in the combination is between 150:1 to 35:1.

In some embodiments, mixed with water refers to adding water to the composition.

In some embodiments, mixed with water refers to adding the composition into the water.

In some embodiments, mixed with water (aqueous media) refers to adding water to the organo-silicone based surfactant and/or adding the organo-silicone based surfactant into the water prior to mixing with the water dispersible solid composition of acetamiprid and cyantraniliprole.

In some embodiments, mixed with water refers to adding water to the water dispersible solid composition of acetamiprid and cyantraniliprole and/or adding the water dispersible solid composition.

In some embodiments the organo-silicone surfactant is incorporated in the water dispersible solid composition by being dissolved or dispersed in water and the resultant liquid being used or employed as a granulation fluid for granulating a combination of particulate acetamiprid and particulate cyantraniliprole to prepare the water dispersible solid composition as a water dispersible granulate composition.

In some embodiments a surfactant is incorporated in the water dispersible solid composition by being dissolved or dispersed in water and the resultant liquid being used or employed as a granulation fluid for granulating a combination of particulate acetamiprid and particulate cyantraniliprole to prepare the water dispersible solid composition as a water dispersible granulate composition.

In some embodiments a surfactant is incorporated in the water dispersible solid composition by being dissolved or dispersed in water and the resultant liquid being used or employed as a granulation fluid for granulating a combination of particulate acetamiprid co-milled with lactose and particulate cyantraniliprole to prepare the water dispersible solid composition as a water dispersible granulate composition.

In some embodiments a surfactant is incorporated in the water dispersible solid composition by being dissolved or dispersed in water and the resultant liquid being used or employed as a granulation fluid for granulating a combination of particulate acetamiprid co-milled with lactose and particulate cyantraniliprole co-milled with dispersant to prepare the water dispersible solid composition as a water dispersible granulate composition.

In some embodiments a surfactant is incorporated in the water dispersible solid composition by being dissolved or dispersed in water and the resultant liquid being used or employed as a granulation fluid for granulating a blend, mixture or combination of,
1) a combination of particulate acetamiprid co-milled with lactose
2) particulate cyantraniliprole
3) solid or liquid agriculturally acceptable additive selected from the group of
   a) dispersing agent/dispersant;
   b) wetting agent,
   c) filler,
   d) binder,
   e) disintegration agent,
   f) anti-foaming agent,
   g) biocide,
   h) water absorbents,
   i) water scavengers,
   j) UV light protectant;
   k) antioxidant;
   l) agricultural adjuvant; and
   m) combinations of two or more thereof
      to prepare the water dispersible solid composition as a water dispersible granulate composition.

In some embodiments the particulate cyantraniliprole is a combination of particulate cyantraniliprole co-milled with one or more solid agriculturally acceptable additives selected from the above group.

A UV light protectant can be any ingredient, excipient, adjuvant, carrier or additive that can mitigate the degrading effect of exposure to UV light at 100-400 nm, exemplified by any, some or all of a UV absorber, an ingredient etc. that exhibits the absorption spectra substantially similar to that of the either acetamiprid or cyantraniliprole such as a suitable dye, colorant or pigment, an ingredient etc. capable of reducing the amount of sunlight impinging on the material, an opacifier, a reflecting pigment such as titanium dioxide and other ingredient having a UV protecting effect.

In some embodiments, the organo-silicone based surfactant is organo-modified tri-siloxane. In some embodiments, the organo-silicone based surfactant is tri-siloxane ethoxylate.

The organo-modified tri-siloxane may be, but is not limited to, Silwet® L77, Silwet 806, BREAK-THRU® S 240 (polyether tri-siloxane), a tri-siloxane alkoxylate or any combination thereof.

Silwet® L-77 and 806 are reportedly Polyalkylene oxide modified heptamethyl tri siloxanes.

Breakthru® S 240 is reported to be oxirane, methyl-, polymer with oxirane, mono-3]-1,3,3,3]tetramethyl-1 [(trimethylsilyl)oxy]disiloxanyl]propyl]ether. Or 3-hydroxypropyl methyl, ethoxylated propoxylated siloxanes and silicones,

In some embodiments, the organo-silicone based surfactant has the following structure:

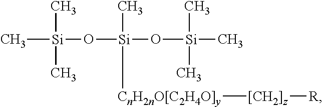

wherein n=1-4, y=3-10, z=0-5, and R is an alkyl having 1-4 carbon atoms or H or OH.

In some embodiments, the organo-silicone based surfactant is Silwet® L77.

In some embodiments, the organo-silicone based surfactant is 3-(8-methoxyoctoxy)propyl-methyl-bis(trimethyl silyl oxy)silane.

In some embodiments, the organo-silicone based surfactant has the following structure reproduced from Stevens, P. J. G. Organosilicone Surfactants as Adjuvants for Agrochemicals. Pestic. Sci. 1993, 38, 103-122.

| 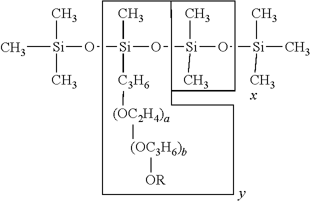 | | | |
|---|---|---|---|
| 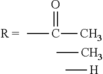 | | | |
| Typical compositions | | | |
| a | b | y | x |
| 6-8 | 0 | c.1 | 0 |
| c.6 | c.3 | 1-1.5 | 0 |

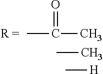

In some embodiments the organo-silicone surfactant has the following structure, poly alkylene oxide modified tri-siloxane polyalkylene oxide modified tri-siloxane.

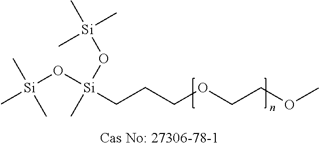

In some embodiments, the amount of organo-silicone based surfactant in the water dispersible solid composition is between about 0.1% to about 2% w/w based on the total weight of the composition.

In some embodiments, the water dispersible solid composition comprises at least one agriculturally acceptable additive. In some embodiments, the agriculturally acceptable additive is in solid form.

In some embodiments, the agriculturally acceptable additive is selected from the group consisting of dispersing agent, wetting agent, filler, binder, disintegration agent, anti-foaming agent, biocides, water absorbents, water scavengers, adjuvants and any combination thereof. In some embodiments, the agriculturally acceptable additive is selected from the group consisting of dispersing agent, wetting agent, filler, binder, disintegration agent and any combination thereof. In some embodiments, the agriculturally acceptable additive is a dispersing agent. In some embodiments, the agriculturally acceptable additive is a wetting agent. In some embodiments, the agriculturally acceptable additive is a filler. In some embodiments, the agriculturally acceptable additive is a binder.

Agriculturally acceptable additives include, but are not limited to, dispersing agent(s), wetting agent(s), filler(s), binder(s), disintegration agent(s), anti-foaming agent(s), biocide(s), water absorbent(s), water scavenger(s), adjuvant(s) and any combination thereof. Preferred agriculturally acceptable additives that may be used for formulating the water dispersible solid composition of the present invention are described herein.

In some embodiments, agriculturally acceptable additive is a compound that is known and accepted in the art for use in the formation of solid compositions for agricultural or horticultural use.

In some embodiments, the solid composition comprises at least one additive.

In some embodiments, the additive is solid. In some embodiments, the additive is liquid.

In some embodiments, the additive is selected from the group consisting of surfactant such as (dispersing agents, wetting agents, emulsifying agents), anti-foaming agent, biocides, water absorbents, water scavengers, adjuvants and any combination thereof.

In some embodiments, the additive is selected from the group consisting of dispersing agents, wetting agents, emulsifying agents and any combination thereof.

In some embodiments, the solid composition further comprises at least one disintegration agent.

In some embodiments, the disintegration agent is inorganic salts (such as NaCl), blooming agent, an effervescence system or a combination thereof.

In some embodiments, the effervescent system comprises a mixture of an acid and a base, preferably a weak acid and a weak base. However, the effervescent system that may be used with the formulations described herein is not limited to the combination of an acid and a base.

Chemical reaction between an acid and a base can result in a rapid spontaneous evolution of CO₂ gas when the effervescent system is combined with and wetted by water. In-situ formation of gas enhances solid disintegration and/or particles dispersion.

When the disintegration system of the solid water dispersible composition is an effervescent system comprises a mixture of an acid and a base which react on contact with water, efforts should be made to limit the moisture content of the solid water dispersible composition to as low a value as is practical, such as below 3% w/w and packaging the solid water dispersible composition, wherein the package is impermeable to moisture, such that the effervescent system comprised in the composition contained in the package does not react when the package is exposed to humid air

Acids may include, but are not limited to, organic and inorganic acids. The inorganic acid may be a weak acid. Organic acids may include but are not limited to carboxylic acids such as citric acid, fumaric acid, phthalic acid, maleic acid, malic acid, oxalic acid, adipic acid, glutaric acid, 2-methyl glutaric acid, succinic acid and tartaric acid or any combination thereof.

Bases may include, but are not limited to, organic and inorganic bases. The inorganic base may be a weak base. Inorganic base may include but is not limited to an alkali metal carbonate or bicarbonate such as lithium carbonate, sodium carbonate, sodium bicarbonate, potassium carbonate, potassium bicarbonate or any combination thereof.

In some embodiments, wherein the composition comprises disintegration agent (disintegrant), the concentration of the disintegration agent is about 0.1% to about 15% by weight based on the total weight of the composition.

In some embodiments, the concentration of the effervescent system where present, is about 0.1% to about 15% by weight based on the total weight of the composition.

In some embodiments, the composition comprises a wetting agent.

In some embodiments, the wetting agent and/or surfactant may include, but is not limited to alkyl naphthalene sulfonate (such as sodium), phenyl sulfonic acid (such as sodium), alcohol ethoxylate, sodium lauryl sulfate, polyalkoxylated butyl ether, polyaryl phenyl phosphate ether, docusate sodium, organo-silicone (organo-silicon-based) surfactant such as an organo-modified tri-siloxane, and any combination thereof. Persons skilled in these formulation art will immediately recognize other wetting agents that can replace any of the wetting agents exemplified, and inventors foresee these alternatives as being within their intention.

In some embodiments, the wetting agent is selected from the group of sodium alkyl naphthalene sulfonate, sodium phenyl sulfonic acid, alcohol ethoxylate, sodium lauryl sulfate, polyalkoxylated butyl ether, polyaryl phenyl phosphate ether, sodium docusate, and any combination thereof.

In some embodiments, the wetting agent is docusate sodium. (Aerosol® OT-B) In some embodiments, the concentration of wetting agent is between about 0.01% to about 10% by weight based on the total weight of the composition.

In some embodiments, the composition comprises a dispersing agent (dispersant).

In some embodiments, the dispersing agent may include, but are not limited to from the group of condensate of alkyl naphthalene sulfonate formaldehyde, alkoxylated alcohol, silicone surfactant, alkyl naphthalene sulfonate condensate, sodium salt, ethoxylated fatty alcohol, hydrophobically modified polyacrylate (such as modified styrene acrylic polymer e.g., Atlox® Metasperse 550S), lignosulfonates, polyelectrolyte block copolymer (as described in WO2017/098325) e.g., AMPS-ethyl acrylate co-polymer, alkyl sulfonates, alkyl benzene sulfonates, alkylaryl sulfonates, alkyl phenol alkoxylates, tristyryl phenol ethoxylates, synthetic or natural fatty ethoxylates alcohols synthetic or natural fatty, block copolymers (such as ethylene oxide-propylene oxide block copolymers and ethylene oxide-butylene oxide block copolymers), synthetic or natural fatty alcohol alkoxylates, alkoxylated alcohols (such as poly glycol ether of n-butyl alcohol), polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or poly-oxyalkylene, quaternary ammonium compounds and fatty amine salts, salts of alkylaryl sulfonic acids, salts or sulfated polyglycol ethers, salts of phosphated polyglycol ether and any combination thereof.

In some embodiments, the dispersing agent is selected from the group consisting of condensate of alkyl naphthalene sulfonate formaldehyde, alkoxylated alcohol, silicone surfactant, methyl naphthalene sulfonate condensate, sodium salt, ethoxylated fatty alcohol, hydrophobically modified polyacrylate (such as Modified styrene acrylic polymer), lignosulfonates, polyelectrolyte block copolymer (as described in WO2017/098325) AMPS-Ethyl acrylate block co-polymer, and any combination thereof.

In some embodiments, the dispersing agent is selected from the group consisting of condensate of alkyl naphthalene sulfonate formaldehyde, alkoxylated alcohol, silicone surfactant, methyl naphthalene sulfonate condensate, sodium salt, ethoxylated fatty alcohol, hydrophobically modified polyacrylate (such as Modified styrene acrylic polymer), lignosulfonates, polyelectrolyte block copolymer (as described in WO2017/098325) and any combination thereof.

In some embodiments, the dispersing agent is a block polymer comprising 77% of sodium 2-acryloylamino-2-methylpropane sulfonate (AMPS) monomers and 23% of ethyl acrylate (EA) monomers.

In some embodiments, the dispersing agent is a water solution of 30% by weight solution of a block polymer comprising 77% of sodium 2-acryloylamino-2-methylpropane sulfonate (AMPS) monomers and 23% of ethyl acrylate (EA) monomers, which may be prepared as described in Example 1 of WO2017/098325. The water content of the dispersing agent solution is dried out of the solid composition as described herein below.

In some embodiments, the concentration of the block polymer where present is between about 0.1% to about 5% by weight based on the total weight of the composition.

In some embodiments the dispersing agent is hydrophobically modified polyacrylate (such as modified styrene acrylic polymer e.g., Atlox® Metasperse 550S), lignosulfonates or combinations thereof.

In some embodiments, the concentration of dispersing agent is between about 0.01% to about 20% by weight based on the total weight of the composition.

In some embodiments, the concentration of dispersing agent(s) is between about 1% to about 10% by weight based on the total weight of the composition.

In some embodiments, the composition comprises additional agricultural active ingredient besides acetamiprid and cyantraniliprole.

In some embodiments, the water dispersible solid composition comprises a wetting agent.

In some embodiments, the water dispersible solid composition comprises a dispersing agent. In some embodiments, the water dispersible solid composition comprises two or more dispersing agents.

In some embodiment, the water dispersible solid composition comprises a combination of wetting agent and dispersing agent.

In some embodiments, the dispersing agent is solid. In some embodiments, the dispersing agent is liquid and in some embodiments a mixture of a liquid and solid dispersants.

In some embodiments, the dispersing agent has a polymeric structure.

In some embodiments, the dispersing agent is an ionic compound.

In some embodiment, the dispersing agent is an ionic compound having a polymeric structure.

In some embodiments, the dispersing agent is an anionic compound.

In some embodiment, the dispersing agent is an anionic compound having a polymeric structure.

Dispersing agent may include, but is not limited to, condensate of alkyl naphthalene sulfonate formaldehyde, alkoxylated alcohol, alkyl naphthalene sulfonate condensate, sodium salt, ethoxylated fatty alcohol, hydrophobically modified polyacrylate (such as modified styrene acrylic polymer), lignosulfonates, polyelectrolyte block copolymer (as described in WO2017/098325) and any combination thereof.

In some embodiments, the dispersing agent is selected from hydrophobically modified polyacrylate such as modified styrene acrylic polymer, a copolymer of AMPS and ethyl acrylate, alkyl naphthalene sulfonate formaldehyde condensate, polycarboxylate (such as di-iso butylene maleic acid co-polymer, sodium salt), lignosulfonates and combination thereof.

In some embodiments, the dispersing agents are any of, Borresperse Ca or Na, TERSPERSE® 2500 (acrylic graft copolymer in water/propylene glycol), and Atlox® Metasperse 550S.

In some embodiments, the agricultural acceptable solid additive is filler and/or binder. In some embodiments, the agricultural acceptable solid additive is dispersible in water. In some embodiments, the agricultural acceptable solid additive is soluble in water.

In some embodiments, the agriculturally acceptable solid additive is a solid filler.

In some embodiments, the agriculturally acceptable solid additive is binder.

In some embodiments, the agriculturally acceptable solid additive can function as filler and/or binder.

Agriculturally acceptable solid additive may include, but is not limited to silica, clay, corn starch, talc, lactose monohydrate, ammonium sulfate (binder and filler), sucrose, magnesium stearate, glucose, cellulose, calcium carbonate, and any combination thereof. In some embodiments, the filler and/or binder is selected from the group consisting of silica, clay, corn starch, talc, lactose monohydrate, ammonium sulfate (binder and filler), sucrose, magnesium stearate, glucose, cellulose, calcium carbonate, and any combination thereof.

In some of the embodiments of the invention particulate acetamiprid is blended with an agriculturally acceptable solid additive and then milled separately from cyantraniliprole before being combined with particulate cyantraniliprole in the solid dispersible composition.

In some of the embodiments of the invention particulate acetamiprid is blended with solid lactose and then milled separately from cyantraniliprole before being combined with particulate cyantraniliprole in the solid dispersible composition.

In some of the embodiments of the invention particulate cyantraniliprole is blended with solid additive such as dispersant and then milled separately from the blend of co-milled acetamiprid and lactose before being combined with particulate acetamiprid in the solid dispersible composition.

In some embodiments, the agriculturally acceptable solid additive is selected from the group of silica, clay, corn starch, talc, lactose monohydrate, ammonium sulfate (binder and filler), sucrose, magnesium stearate, glucose, cellulose, calcium carbonate, and any combination thereof. In some embodiments, the filler and/or binder is selected from the group of silica, clay, corn starch, talc, lactose monohydrate, ammonium sulfate (binder and filler), sucrose, magnesium stearate, glucose, cellulose, calcium carbonate, and any combination thereof.

In some embodiments, the agriculturally acceptable solid additive is a combination of corn starch and talc.

In some embodiments, the amount of the agriculturally acceptable solid additive(s) in the water dispersible solid composition is between about 2% to about 50% w/w based on the total weight of the water dispersible solid composition.

In some embodiments, the agriculturally acceptable additive is a functional additive.

In some embodiments, the water dispersible solid composition comprises at least one functional additive.

In some embodiments, the functional additive is solid. In some embodiments, the functional additive is liquid.

In some embodiments, the functional additive is selected from the group of anti-foaming agent, biocides, water absorbents, water scavengers, adjuvants and any combination thereof.

When the water dispersible solid composition is mixed with water, components of the water dispersible solid composition may dissolve in the water and/or disperse in the form of solid particles in the water.

Typically, when the solid water dispersible composition is diluted with or dispersed in water (aqueous media), the particulate acetamiprid dissolves in the aqueous media and the particulate cyantraniliprole is dispersed and/or suspended in the water.

Some compositions according to the invention comprise the following ingredients

| | |
|---|---|
| particulate | about 40% w/w |
| acetamiprid | |
| particulate | About 30% w/w |
| cyantraniliprole | |
| Aerosol OT-B | docusate sodium & sodium benzoate/bis(2- |
| | ethylhexyl)maleate) |
| lactose (monohydrate) | solid carrier |
| corn starch | carrier |
| Silfoam ® SP150 | Polydimethylsiloxane CAS-No. 63148-62-9 |
| | on an inorganic carrier |
| Borresperse Ca | Lignosulphonate |
| Atlox Metasperse 550 s | styrene (meth)acrylic copolymer |
| Silwet L-77 | Poly alkylene oxide Modified Heptamethyl |
| | tri-siloxane |
| water | wetting or granulation liquid |

A general procedure for preparing WDG (water dispersible solid composition in the form of granules) is summarized below.

Step A: preparing solid blend(s) Mixing cyantraniliprole in solid form with an agriculturally acceptable non-insecticidal ingredient such as dispersant, milling the mixture to prepare a blend A, D₉₀ is between about 20 microns to about 40 microns.

Preparing Blend B by Milling a Blend of Acetamiprid and Carrier Such as Lactose to D₉₀ of about 150 Microns to about 200 Microns

### Preparing the Pre-Mix:

Mixing blends, A and B,

### Granulation Process:

wetting the pre-mix with a wetting liquid, optionally comprising surfactant such as organo-silicon-based surfactant.
wet granulation and drying to LOD of about 3% w/w water or less.

| | |
|---|---|
| Particulate | about 40% w/w |
| Acetamiprid | |
| Particulate | about 30% w/w |
| Cyantraniliprole | |
| Aerosol ® OT-B | sodium bis(2-ethylhexyl)sulfosuccinate |
| | (and sodium benzoate/ |
| | bis(2-ethylhexyl)maleate) |
| Lactose | solid carrier |
| Kaolin | solid carrier |
| Silfoam ® SP150 | powder based on polydimethylsiloxane |
| (antifoam 150) | CAS # 63148-62-9 on an inorganic carrier |
| Borresperse (Ca or Na) | lignosulphonate |
| Atlox ® Metasperse 550 S | styrene (meth)acrylic copolymer |
| Silwet L-77 | Poly alkylene oxide modified heptamethyl |
| | tri-siloxane |
| water | granulation fluid |

### Water Diluted Composition

When the water dispersible solid composition of the present invention, which comprises solid particles of acetamiprid and solid particles of cyantraniliprole is mixed contacted or otherwise diluted with water, the cyantraniliprole is dispersed in the water as suspended solid particles and the acetamiprid is dissolved in the water forming an acetamiprid solution within which the solid particles of cyantraniliprole are suspended. In some embodiments the composition is a water dispersible granule or granulate. In some embodiments the water dispersible solid composition of the present invention is a packaged water dispersible granule composition.

In some embodiments the process of obtaining a suspension of solid particulate cyantraniliprole dispersed in an aqueous media as suspended solid particles in an aqueous acetamiprid solution, the process comprising mixing contacting or otherwise diluting the water dispersible solid composition of the present invention with water.

In some embodiments the process of obtaining a suspension of solid particulate cyantraniliprole dispersed in an aqueous media as suspended solid particles in an aqueous acetamiprid solution, the process comprising mixing contacting or otherwise diluting the water dispersible granule or granulate composition of the present invention with water and agitating until disintegration and dispersion of the water dispersible granule or granulate is complete by visual inspection.

In some embodiments the invention provides a process of obtaining a suspension of solid particulate cyantraniliprole dispersed in an aqueous media as suspended solid particles in an aqueous acetamiprid solution from a packaged water dispersible solid composition of the present invention, the process comprising opening a package containing the water dispersible solid composition of the present invention, removing the water dispersible solid composition from the package and mixing contacting or otherwise diluting the water dispersible solid composition of the present invention with water (or aqueous media), and agitating.

In some embodiments the invention provides a process of obtaining a suspension of solid particulate cyantraniliprole dispersed in an aqueous media as suspended solid particles in an aqueous acetamiprid solution from a packaged water dispersible granule or granulate composition of the present invention, the process comprising opening a package containing the water dispersible granule or granulate composition of the present invention, removing the water dispersible granule or granulate composition from the package and mixing contacting or otherwise diluting the water dispersible granule or granulate composition of the present invention with water (or aqueous media), and agitating until disintegration and dispersion of the water dispersible granule or granulate is complete by visual inspection.

In some envisioned embodiments the water dispersible granule composition of the invention is packaged in a water soluble inner package and an outer protective package. The process of obtaining a suspension of solid particulate cyantraniliprole dispersed in an aqueous media as suspended solid particles in an aqueous acetamiprid solution from the packaged water dispersible granule or granulate composition of the present invention, comprising opening the outer protective package containing the water dispersible granule or granulate composition of the present invention, removing the inner soluble package containing the water dispersible granule or granulate composition from the package and then introducing the water soluble package with its contents into water or aqueous media, mixing contacting or otherwise diluting the water dispersible granule or granulate composition of the present invention with water (or aqueous media), and agitating until the soluble packaging has dissolved and disintegration and dispersion of the water dispersible granule or granulate is complete by visual inspection.

In some embodiments the packaged water dispersible solid composition of the present invention is a packaged water dispersible granule or granulate composition.

The present invention provides a water diluted composition comprising any one of the combinations and/or compositions described herein and water.

The present invention provides a water diluted composition prepared from the compositions described herein.

The present invention provides a water diluted composition comprising any one of the water dispersible solid compositions or combinations described herein and water. The present invention provides a water diluted composition prepared by using any water dispersible solid composition or combination described herein where using can be diluting, dispersing, contacting, etc.).

The present invention provides a water diluted composition comprising cyantraniliprole and acetamiprid, wherein the cyantraniliprole is suspended in water as solid particles and the acetamiprid is dissolved in the water, characterized by reduced or absent, deactivating interactions between acetamiprid and cyantraniliprole as compared with compositions not prepared according to the invention.

In some embodiments, physical stability of the water diluted composition refers to a state when the solid cyantraniliprole particles are dispersed in a solution of acetamiprid and no significant agglomeration is observed. Significance in this regard refers to a level as specified for an acceptable dispersion as herein defined.

### Methods of Use

The present invention also provides a method for controlling unwanted insects comprising applying an effective amount of any one of the herein described combination and/or composition to a plant, a locus thereof, propagation material thereof, or an area infested with the unwanted insects so as to thereby control the unwanted insects. The application is typically achieved by first diluting the solid combination or solid composition of the invention in water or aqueous media (Tank-mix) and applying the resultant liquid.

The present invention also provides a method for controlling plant disease caused by unwanted insect comprising applying an effective amount of any one of the herein described combination and/or composition to a plant, a locus thereof, propagation material thereof, or an area infested with the unwanted insect so as to thereby control the plant disease caused by unwanted insect. The application is typically achieved by first diluting the solid combination or solid composition of the invention in water or aqueous media (Tank-mix) and applying the resultant liquid.

In some embodiments, the locus of the plant is the vicinity of the plant.

In some embodiments, the area infested with the unwanted insects is a plant.

In some embodiments, the water diluted composition is obtained using one of the processes of preparation described herein. In some embodiments the water diluted composition is obtained by introducing into water the composition of the invention in the form of a water dispersible granule or granulate and agitating until the granules are disintegrated and dispersed in the water by visual inspection.

In some embodiments the water diluted composition is a dispersion and/or a suspension of particulate cyantraniliprole in an aqueous solution of acetamiprid. The water diluted compositions made possible by diluting the solid composition of the invention are characterized by good dispersibility, suspensibility, and foaming with a low levels of particles retained on a wet sieve when the water diluted is passed through a sieve of 75 micron aperture. The water diluted compositions made possible by diluting the solid composition of the invention are characterized by physical and chemical stability as defined herein.

The present invention also provides a method for controlling unwanted insects comprising (1) obtaining a water diluted composition described herein and (2) contacting a plant, a locus thereof, propagation material thereof, or an area infested with the unwanted insects with an effective amount of the suspension so as to thereby control the unwanted insects.

The present invention also provides a method for controlling plant disease caused by unwanted insect, comprising (1) obtaining a water diluted composition described herein and (2) contacting a plant, a locus thereof, propagation material thereof, or an area infested with the unwanted insects with an effective amount of the suspension so as to thereby control the plant disease.

In some embodiments, both the method for controlling unwanted insects and the method for controlling plant disease caused by unwanted insect, comprises as step (1) comprises (i) obtaining a water dispersible solid composition described herein, and (ii) mixing, contacting or otherwise diluting the water dispersible solid composition with water to obtain the water diluted composition.

In some embodiments the water dispersible solid composition is a packaged water dispersible granule or granulate and the method for obtaining a water dispersible solid composition of step 1 comprises first opening the package and removing the water dispersible granule or granulate from the package before mixing, contacting or otherwise diluting the water dispersible granule composition with water. In some embodiments the mixing contacting or otherwise diluting with water is accompanied with agitation until the granules are disintegrated and dispersed in the water by visual inspection.

In some embodiments the water dispersible solid composition is a packaged water dispersible granule or granulate, wherein the package is an inner water soluble container within an outer protective package as detailed herein, and the method for obtaining a water dispersible solid composition of step 1 comprises first opening the outer protective package and removing the water soluble inner package containing the water dispersible granule or granulate from the outer packaging and then introducing the water soluble package containing the water dispersible granule composition into water or aqueous media accompanied with agitation until the water soluble inner package has dissolved and the granules are disintegrated and dispersed in the water by visual inspection.

The present invention also provides a method for controlling unwanted insects and/or plant diseases resulting from infestation by unwanted insects comprising
i) obtaining a water dispersible solid composition described herein,
ii) mixing the water dispersible solid composition with or in water to obtain a water diluted suspension composition comprising dispersed suspended particulate cyantraniliprole in an aqueous solution of acetamiprid, and
iii) contacting a plant, a locus thereof, propagation material thereof, or an area infested with the unwanted insects with an effective amount of the suspension so as to thereby control the unwanted insects.

The present invention also provides a method for controlling plant disease caused by unwanted insect comprising
i) obtaining a water dispersible solid composition described herein,
ii) mixing, contacting or otherwise diluting the water dispersible solid composition with or in water to obtain a water diluted suspension composition comprising dispersed suspended particulate cyantraniliprole in an aqueous solution of acetamiprid, and
iii) contacting a plant, a locus thereof, propagation material thereof, and/or an area infested with the unwanted insect with an effective amount of the suspension so as to thereby control the plant disease caused by unwanted insect.

In some embodiments, the water dispersible solid composition obtained in step i) is substantially free of organo-silicone based surfactant and step ii) comprises mixing an organo-silicone based surfactant with the water dispersible solid composition and water.

In some embodiments, the water dispersible solid composition obtained in step i) comprises an organo-silicone based surfactant and step ii) comprises mixing an organo-silicone based surfactant with the water dispersible solid composition and water.

In some embodiments, the water dispersible solid composition obtained in step i) comprises a water dispersible granule composition wherein an organo-silicone based surfactant mixed with or dissolved in water is used to granulate the solid ingredients of the water dispersible solid composition and step ii) comprises mixing an organo-silicone based surfactant with the water dispersible solid composition and water.

In some noted embodiments the water dispersible granule composition of the invention comprises a co-milled combination, blend or admix of acetamiprid and a carrier selected from lactose, starch and kaolin, which is combined with a separately milled particulate cyantraniliprole, and solid agricultural formulation additives granulated with a solution or mixture of water and surfactant, and dried.

In some embodiments the co-milled combination or admix of acetamiprid and a carrier is characterized by a particle size distribution such that D₉₀ value is between about 150 microns and about 200 microns. In some noted embodiments the carrier is lactose

In some embodiments the separately milled particulate cyantraniliprole, is a co-milled combination blend or admix of particulate cyantraniliprole and agricultural formulation additives co-milled such that D₉₀ value is between about 20 microns and about 40 microns. In some noted embodiments the agricultural formulation additive is a dispersant and/or disintegrant, as described herein.

In some embodiments, step ii) comprises mixing the organo-silicone based surfactant with the water before the water dispersible solid composition is mixed with water.

In some embodiments, step ii) comprises mixing the water dispersible solid composition with the water before the organo-silicone based surfactant is mixed with the water.

In some embodiments, step ii) comprises mixing the water dispersible solid composition and the organo-silicone based surfactant with the water simultaneously.

In some embodiments, the water dispersible solid composition is obtained using one of the processes of preparation described herein.

In some embodiments, the area infested with unwanted insects is a plant. In some embodiments, the area infested with unwanted insects is soil.

Controlling unwanted insects includes preventing infestation by unwanted insects and/or reducing the number of unwanted insects in the area, or otherwise incapacitating unwanted insects if present.

In some embodiments, the method is effective for preventing infestation by unwanted insects. In some embodiments, the method is effective for reducing the number of unwanted insects.

The suspension applied for controlling unwanted insect infestation and/or plant disease may be applied as persistence treatment and/or knock down treatment. In some embodiments, the suspension is applied as a persistence treatment. In some embodiments, the suspension is applied as a knockdown treatment.

In some embodiments, the method is effective for preventing the plant disease caused by unwanted insects. In some embodiments, the method is effective for curing the plant disease caused by unwanted insects.

In some embodiments, the particle size of the cyantraniliprole solid particles in the suspension obtained by diluting the water dispersible solid composition of the invention in aqueous media is such that more than 90% or more of the cyantraniliprole particles by volume or weight, are 20 microns or less.

In some embodiments, the particle size of the cyantraniliprole solid particles in the suspension obtained by diluting the water dispersible solid composition of the invention in aqueous media is such that 90% or more of the cyantraniliprole particles by volume or weight, are 40 microns or less.

In some embodiments, the particle size of the cyantraniliprole solid particles in the suspension obtained by diluting the water dispersible solid composition of the invention in aqueous media is such that 90% or more of the cyantraniliprole particles by volume or weight, are between about 20 microns and about 40 microns.

In some embodiments, the solid granular combination or solid composition is diluted and applied at a diluted concentration of from about 100 ppm to about 1000 ppm of acetamiprid and cyantraniliprole. In some embodiments, the solid granular combination or solid composition is diluted and applied at a diluted concentration of from about 100 ppm to about 500 ppm of acetamiprid and cyantraniliprole. In some embodiments, the solid granular combination or solid composition is diluted and applied at a diluted concentration of from about 200 ppm to about 400 ppm of acetamiprid and cyantraniliprole. In some embodiments, the solid granular combination or solid composition is diluted and applied at a diluted concentration of about 200 ppm of acetamiprid and cyantraniliprole. In some embodiments, the solid granular combination or solid composition is diluted and applied at a diluted concentration of about 200-500 ppm of acetamiprid and cyantraniliprole.

In some embodiments, the suspension obtained by diluting or contacting the compositions of the invention is applied once in a growing season.

In some embodiments, the suspension obtained by diluting or contacting the compositions of the invention is applied at least two times per growing season.

In some embodiments, the granular composition of the invention is applied to soil. In some embodiments, the composition is applied to foliage.

In some embodiments the composition of the invention is applied to soil, to structures plants, livestock or pets, and wood as an undiluted solid granular composition.

In some embodiments, the solid composition of the invention is applied to soil. In some embodiments, the composition is applied to foliage. In some embodiments the composition of the invention is applied to soil, to structures plants, livestock or pets and wood as an undiluted solid composition.

In some embodiments the composition of the invention is applied to soil, to structures, plants, livestock or pets and wood as an undiluted solid granular composition. In some embodiments, the method of using the compositions as an insecticide and/or pesticide comprises applying the dry (dried), composition of the invention directly to the area or location that requires control, prevention or eradication of an insect pest infestation.

In some embodiments, the solid granular combination or solid composition of the invention is diluted and applied at a diluted concentration of from about 100 ppm to about 1000 ppm of acetamiprid and cyantraniliprole to provide insecticidal efficacy.

In some embodiments the diluted solid composition of the invention is characterized by improved persistence. In some embodiments the diluted water dispersible granules of the invention display a persistence of between about 10 to about 14 days after application.

In some embodiments, the method comprises mixing the water dispersible solid composition with water to obtain a water diluted composition in a water tank prior to application. In some embodiments water diluted composition in a water tank is a suspension of cyantraniliprole dispersed in an aqueous solution of acetamiprid.

The combinations, compositions and methods described herein are particularly effective for controlling insects of, inter alia, the orders Lepidoptera, Coleoptera, Homoptera, Heteroptera, Diptera, Thysanoptera, Orthoptera, Anoplura, Siphonaptera, Mallophaga, Thysanura, Isoptera, Psocoptera and Hymenoptera, as well as representatives of the order Acarina of the families Ixodidae Argasidae, Tetranychidae and Dermanyssidae leaf rollers. Amongst others the combinations, compositions and methods described herein are particularly effective for controlling aphids as well as insects sensitive to either or both of acetamiprid and/or cyantraniliprole.

The combinations, compositions, suspensions and methods described herein are also effective in controlling flies, e.g., Musca domestica, termites, cockroaches and mosquito larvae.

The solid compositions of the invention are usefully applied to locations that would benefit from the application of an insecticidal combination of acetamiprid and cyantraniliprole. In many embodiments, the solid compositions of the invention are diluted in aqueous media (water), prior to application.

The application of the solid compositions of the invention or diluted liquids prepared from them are usefully applied to plants, crops, soil, structures, wood or other locations where control or eradication or prevention of insect infestation is desired.

The combinations, compositions, suspensions and methods described herein are also suitable for controlling plant-destructive feeding insects in ornamentals and crops of useful plants, especially in cotton (e. g. against Spodoptera littoralis and Heliothis virescens) and in fruit and vegetables (e. g. against Laspeyresia pomonella, Cydia pomonella, Lithocolletis blancardella, Stigmella malella, 4doxophyes orana, Psylla piri, Cryptophlebia leucotreta, Phyllocnistis citrella, Cydia molesta, Anarsia lineatella, Leptinotarsa decemlineata and Epilachna varivestis), as well as for controlling several species of mites, e. g., oleivora.

The combinations and compositions disclosed herein may be applied to control and/or prevent a variety of insect species in the presence of plant or its location, a structure, livestock or pets and wood.

In some embodiments, the plant is a crop. In some embodiments, the crop is a soft crop such as vegetable and fruits.

The methods of the present invention may be used on any crop plants, including but not limited to monocotyledons such as sugar cane cereals, rice, maize (corn), and/or; or dicotyledon crop such as beets (such as sugar beet or fodder beet); fruits (such as pomes, stone fruits, or soft fruits, for example apples, pears, plums, peaches, almonds, cherries, strawberries, raspberries, or blackberries); leguminous plants (such as beans, lentils, peas, or soybeans); oil plants (such as rape, mustard, poppy, olives, sunflowers, coconut, castor oil plants, cocoa beans, or groundnuts); cucumber plants (such as marrows, cucumbers or melons); fiber plants (such as cotton, flax, hemp, or jute); citrus fruits (such as Winegrapes, oranges, lemons, grapefruit, or mandarins); vegetables (such as spinach, lettuce, cabbages, carrots, tomatoes, potatoes, cucurbits, or paprika); lauraceae (such as avocados, cinnamon, or camphor); tobacco; nuts; coffee; tea; vines; hops; durian; bananas; natural rubber plants; and ornamentals (such as flowers, shrubs, broad-leaved trees, or evergreens, for example conifers).

In some embodiments, the plants are monocotyledonous plants, more preferably, cereals. In a specific embodiment, the cereal crop is wheat. In another specific embodiment, the cereal crop is triticale. In another specific embodiment, the cereal crop is rye. In another specific embodiment, the cereal crop is oat. In a further embodiment, the cereal crop is barley. In another embodiment, the crop plants are rice plants. In still another embodiment, the crop plants are sugar cane plants. In yet another embodiment, the crop plants are corn plants.

The combinations, compositions, suspensions and methods described herein are further effective for controlling ectoparasites such as Lucilia sericata, in domestic animals and productive livestock, e. g. by treating animals' skin, cowsheds, barns, stables etc., and pastures.

According to a particular embodiment of the present method, the pesticidal composition is used to prepare a tank mix which is then applied via spraying to the area or crop needing treatment. The active ingredient concentration in the tank mix is adjusted to the particular application, depending on agricultural or non-agricultural application, the crop and the pest. Although various methods of application may be employed as the skilled artisan may appreciate, spraying is the preferred method of application.

In some embodiments, the method comprises applying the combination or composition, in conjunction with other pest control agents, either in a mixture or by sequential application.

### Preparation of Water Dispersible Solid Composition

In typical embodiments the water dispersible solid composition of the present invention is prepared by wet granulation.

In some embodiments the present invention provides a process for preparing a water dispersible solid composition comprising acetamiprid and cyantraniliprole, the process comprising (1) preparing a pre-mix of all the solid components, (2) wetting the pre-mix of step (1) with a wetting liquid, (4) performing wet granulation and drying.

In some embodiments the present invention provides a process for preparing a water dispersible granule composition comprising particulate acetamiprid, particulate cyantraniliprole, solid agricultural carrier, additives and surfactant the process comprising (1) preparing a pre-mix of all the solid components, (2) wetting the pre-mix of step (1) with a wetting liquid comprising a mixture or solution comprising water and surfactant, (4) performing wet granulation to obtain a wet granulate, (5) drying the wet granulate to a water content of about 3% or less. In noted embodiments the process is completed by packaging the obtained water dispersible granule composition in protective packaging as described herein.

In some embodiments the present invention provides a process for preparing a water dispersible granule composition comprising particulate acetamiprid, particulate cyantraniliprole, solid agricultural carrier, additives and surfactant the process comprising
1. Co-milling a blend or mixture of acetamiprid and carrier such as lactose to achieve a particle size distribution such that D₉₀ of the particles is between about 150 microns and about 200 microns,
2. Separately milling cyantraniliprole to achieve a particle size distribution such that D₉₀ of the particles is between about 20 microns and about 40 microns,
3. preparing a pre-mix of the co-milled acetamiprid separately milled cyantraniliprole and the solid components including dispersants,
4. wetting the pre-mix of step 3. with a wetting liquid comprising a mixture or solution comprising water and surfactant,
5. performing wet granulation to obtain a wet granulate,
6. drying the wet granulate to a water content of about 3% or less.
7. In noted embodiments the process is completed by packaging the obtained water dispersible granule composition in protective packaging as described herein.

In some embodiments the present invention provides a process for preparing a water dispersible granule composition comprising particulate acetamiprid, particulate cyantraniliprole, solid agricultural carrier, additives and surfactant the process comprising
1. co-milling a blend or mixture of acetamiprid and carrier such as lactose to achieve a particle size distribution such that D₉₀ of the particles is between about 150 microns and about 200 microns,
2. separately co-milling a blend or mixture of cyantraniliprole and solid composition components including dispersants to achieve a particle size distribution such that D₉₀ of the particles is between about 20 microns and about 40 microns,
3. preparing a pre-mix of the co-milled acetamiprid and the separately co-milled cyantraniliprole,
4. wetting the pre-mix of step 3. with a wetting liquid comprising a mixture or solution comprising water and surfactant,
5. performing wet granulation to obtain a wet granulate,
6. drying the wet granulate to a water content of about 3% or less.
7. In noted embodiments the process is completed by packaging the obtained water dispersible granule composition in protective packaging as described herein.

Generally, as will be immediately appreciated the process for preparing the solid water dispersible compositions of the invention can start from purchased or otherwise obtained particulate acetamiprid and/or purchased or otherwise obtained particulate cyantraniliprole rather than performing milling steps, so long as the particulate acetamiprid has a particle size distribution such that the D₉₀ value is between about 150 microns to about 200 microns and/or the particulate cyantraniliprole has a particle size distribution such that the D₉₀ value is between about 20 microns to about 40 microns. However, inventors see advantages in the particulate acetamiprid being co-milled with solid carrier ingredients such as lactose and starch etc. both as regards lowering the persistent foam produced when the water dispersible solid formulation is introduced into water forming the diluted composition prior to insecticidal application, and also advantages are noted in optimizing the rate of dissolution of the acetamiprid particles in the diluted composition.

The present invention provides a process for preparing a water dispersible solid composition comprising acetamiprid and cyantraniliprole, the process comprising (1) preparing a pre-mix of all the solid components, (2) wetting the pre-mix of step (1) using a water-based wetting liquid optionally comprising organo silicon based surfactant to obtain a wetted solid composition, and (4) drying the obtained wetted solid composition.

In some embodiments, pre-mix is a mixture of two solid blends.

In some embodiments, step of milling the acetamiprid and cyantraniliprole is conducted prior to step (1).

In some embodiments, the pre-mix is mixture of solid blends with two different distribution of particles size. Typically, the particle size distribution of each blend are such as to be incompatible with a process whereby both cyantraniliprole and acetamiprid particulates are co-milled. Advantages are achieved when particulate acetamiprid is milled as a blend with a carrier such as lactose, starch or kaolin.

Generally, it is found that the milling process of acetamiprid is advantageously conducted on a blend of acetamiprid and a carrier such as lactose because acetamiprid is difficult to mill neat and additionally the characteristics of such a co-milled blend are improved when used as a component in the compositions.

In some embodiments, the milling is a dry milling.

In some embodiments, the initial process step for preparing the inventive compositions comprises separate milling steps whereby the acetamiprid and the cyantraniliprole are milled. In the alternative, either or both of acetamiprid and cyantraniliprole are purchased or otherwise obtained characterized by the desired particle size distribution.

In some embodiments, the inventive solid compositions comprising acetamiprid and cyantraniliprole are water dispersible granules comprising an aqueous wetting liquid such as water, in liquid-solid intimate association with a combination of separately milled particulate acetamiprid and separately milled particulate cyantraniliprole such that a solid intimate association between acetamiprid and cyantraniliprole is thus avoided, wherein the content of water in the water dispersible granules is 5% w/w or less, though usefully between about 3% and about 0.5% w/w by weight of the granule.

In some embodiments the aqueous wetting liquid is a combination of water and surfactant such as an organo-silicone surfactant, which is in liquid-solid intimate association with the combination of separately milled particulate acetamiprid and separately milled particulate cyantraniliprole.

In some embodiments, the invention provides methods for preparing a suspension comprising particulate cyantraniliprole suspended in an aqueous solution of acetamiprid characterised in that a deactivating interaction resulting in reduced pesticidally/insecticidally available acetamiprid and/or cyantraniliprole content in the suspension is avoided.

The method comprises diluting and/or dispersing in water, solid water dispersible granules (WDG), comprising a combination of separately milled particulate acetamiprid and separately milled particulate cyantraniliprole such that a solid intimate association between acetamiprid and cyantraniliprole in the granules is prevented, so as to obtain a suspension comprising particulate cyantraniliprole suspended in an aqueous solution of acetamiprid characterised in that significant reduction of acetamiprid and cyantraniliprole content in the suspension is avoided. An initial indication of a significant deactivating interaction often associated with particle size growth, can be seen by a rise in the retained solids above about 2% in a wet sieve retention (WSR), test, usefully the test involves passing the obtained suspension through a 75 micron sieve.

The sieve used in the WSR test usefully has apertures larger than the size of the solid particles of cyantraniliprole in the WDG such that the retained solids are attributable for example, to agglomerates etc., that have formed by e.g., a deactivating interaction, or particle size growth through solid-form conversion or similar processes such as dissolution/recrystallization in the aqueous medium.

However, particular advantages are noted where the acetamiprid is in intimate solid association with the carrier particle which is exemplified by the solid intimate association obtained when acetamiprid is co-milled with starch, lactose, and or kaolin, notably lactose.

Similarly, advantages are noted where the cyantraniliprole is incorporated into the compositions in intimate solid association with the solid agriculturally acceptable additive ingredients of the composition exemplified by any, some, or all of, dispersing agent/dispersant; wetting agent, filler, binder, disintegration agent, anti-foaming agent, biocide, water absorbents, water scavengers, UV light protectant; antioxidant; agricultural adjuvant; and combinations of two or more thereof, which is exemplified by the solid intimate association obtained when cyantraniliprole is co-milled with the solid agriculturally acceptable additive ingredients prior to being combined with the particulate acetamiprid when preparing the composition.

Inventors note the advantages realized when the surfactant ingredient is introduced into the water dispersible granule composition embodiments of the invention in liquid-solid intimate association with the solid particulate acetamiprid, particulate cyantraniliprole, and solid formulation ingredients or additives, and carrier. liquid-solid intimate association is that type of association exemplified by wet granulating the solid particulate acetamiprid, particulate cyantraniliprole, and solid formulation ingredients or additives with an aqueous solution of the surfactant ingredient, prior to drying the obtained granules.

Inventors have noted in this respect that the particle size distribution of solid carrier such as lactose is advantageously included as milled particles with a particle size distribution less than 300 microns (D₉₀), in the solid wettable (dispersible) solid compositions of the invention. This provides another reason for co-milling the acetamiprid together with lactose as an initial process step for preparing the inventive solid compositions of the invention.

As discussed herein the solid compositions of the invention are typically water dispersible granulates. In noted embodiments the granulates are prepared by wet granulation techniques, familiar to those skilled in the formulation arts. In common embodiments the wet granulation comprises a wetting step wherein solid ingredients are wetted by an aqueous solution of the surfactant ingredient, which can comprise the granulation liquid. Organo-silicone surfactant have been herein exemplified but this should not limit the useful range of surfactant ingredients.

Often a further wetting agent is included in the compositions as solids usefully in solid intimate association the separately milled particulate cyantraniliprole by being milled together. In several useful embodiments the separately milled particulate cyantraniliprole is in solid intimate association with a solid wetting agent as well as solid dispersant excipients by milled as a blend.

In some embodiments, the cyantraniliprole is milled in the presence of (or in admixture with) at least one agriculturally acceptable additive prior to preparing a premix in the above methods.

In some embodiments, the cyantraniliprole is milled in the presence of, in admixture with, or blended with a dispersant such as a lignosulphonate, a modified styrene acrylic polymer (e.g., Atlox® Metasperse 550), a co-polymer of AMPS and ethyl acrylate, alkyl naphthalene sulfonate formaldehyde condensate, or polycarboxylate (such as di-iso butylene maleic acid co-polymer, sodium salt), prior to preparing a premix in the above methods.

In some embodiments, the acetamiprid is milled in the presence of (or in admixture with), at least one agriculturally acceptable additive prior to preparing a premix.

In some embodiments the acetamiprid is milled in the presence of, in admixture with, or blended with lactose prior to preparing a premix, wherein the lactose is a carrier in the composition.

In some embodiments, the agriculturally acceptable additive is selected from the group consisting of dispersing agent, wetting agent, filler, binder, anti-foaming agent, biocides, water absorbents, water scavengers, adjuvants and any combination thereof. In some embodiments, the agriculturally acceptable additive is selected from the group consisting of dispersing agent, wetting agent, filler, binder, and any combination thereof. In some embodiments, the agriculturally acceptable additive is a dispersing agent. In some embodiments, the agriculturally acceptable additive is a wetting agent. In some embodiments, the agriculturally acceptable additive is a filler.

In some embodiments, the agriculturally acceptable additive is a binder.

In some embodiments, the cyantraniliprole and at least one agriculturally acceptable additive are milled to a particle size distribution such that the D₉₀ value is between about 20 microns and about 40 microns such as about 30 microns or less, though generally not smaller than about 20 microns.

In some embodiments, the acetamiprid and at least one agriculturally acceptable additive such as lactose are milled to a particle size distribution such that the D₉₀ value is between about 80 microns and about 250 microns such as between about 150 microns to about 200 microns.

In some embodiments, the weight ratio between the premix obtained in the process to the wetting liquid is between about 5:1 to 15:1.

In some embodiments, the wetting liquid is a water-based wetting solution comprising organo-silicon based surfactant.

In some embodiments, the process comprises addition of water as well as an aqueous water-based wetting solution and/or granulation liquid. The addition of water can be either before or after addition of the wetting solution and/or granulation liquid.

In some embodiments, the wetted solid composition is in the form of wet granules.

In some embodiments, water is used for wet granulation. In some embodiments, the amount of water used for wet granulation is between 7 to 20% w/w based on the total weight of the wetted solid composition before drying (during preparation). In some embodiments, the amount of water used for wet granulation is about 10% w/w based on the total weight of the wetted solid composition before drying (during preparation).

The process by which the separately sized particulate acetamiprid and particulate cyantraniliprole are granulated as herein described will be clearly understood by persons skilled in the granulation arts and variations and process optimizations to these process will be immediately apparent. These variations and optimizations are foreseeable and are clearly within the scope of protection of this invention.

In some embodiments, part of the amount of water for wet granulation is added as a solution of water and surfactant.

In some embodiments, part of the amount of water for wet granulation is added as a solution of water and organo-silicone based surfactant.

In some embodiments, the organo-silicone based surfactant is added during the wetting step of granulation.

In some embodiments, the wet granulation is performed by an extrusion type process.

In some embodiments, the extrusion process is conducted with basket extruder or screw extruder, through 1-1.5 mm screen.

In some embodiments, the wet granulation is pan granulation.

In some embodiment, the wetting liquid is sprayed onto the mixture of step (2) to obtain granules.

In some embodiments, the granules are both prepared and dried using a fluidized bed.

In some embodiments, the granules are dried by lyophilization.

In some embodiments, the granules are dried by spray-drying.

In some embodiments, the granules are dried by freeze-drying.

In some embodiments, the granules are dried by diafiltration.

In some embodiments, the granules are dried by dialysis.

In some embodiments, the granules are dried by vacuum drying.

In some embodiments, the granules are dried by heat drying.

### Package and Kit

The present invention provides a package comprising any one of the water dispersible solid compositions described herein, as a packaged solid water dispersible composition.

In some embodiments the invention provides a package comprising any one of the water dispersible solid compositions described herein, as a packaged solid water dispersible composition, wherein the package is a protectant package or container as detailed in this disclosure. The protectant package is characterised in maintaining the characteristics of the water dispersible solid compositions over periods of storage. The protectant packaging and other measures, can advantageously protect the compositions from one or more of,
a. Photodegradation;
b. Premature activation of disintegrant ingredients
c. Premature activation of effervescent ingredients, if present
d. Chemical degradation
e. Ingress of moisture
f. Reductions in flowability
g. Reductions in suspensibility
h. Agglomeration processes.

Some of the advantageous qualities of the compositions of the invention obtained and maintained are only evident once the water dispersible solid compositions are dispersed or diluted in water.

In some embodiments the solid water dispersible solid composition comprises an organo-silicone based surfactant. In some embodiments the organo-silicone based surfactant is incorporated into the composition as a wetting solution in water.

In some embodiments the invention provides a package comprising any one of the water dispersible solid compositions described herein, as a packaged solid water dispersible composition, wherein the composition is packaged first in an inner package and then an outer protectant package which is a protectant package or container as detailed in this disclosure. The inner package need not have the protectant characteristics of the outer packaging and may in some envisioned embodiments, be soluble and/or dispersible in the water in which the composition is designed to be diluted or dispersed, so that the water dispersible solid compositions of the invention need not be exposed to the environment prior to being introduced into water, and the end-user is also not exposed to the solid composition during the process of dilution prior to application.

The present invention provides a packaged kit comprising,
a. A package comprising any one of the water dispersible solid compositions described herein and
b. A package comprising an organo-silicone based surfactant,
   wherein the water dispersible solid composition is substantially free or free of organo-silicone based surfactant.

The present invention provides a package comprising any one of the water dispersible solid compositions described herein and an organo-silicone based surfactant, wherein the water dispersible solid composition comprises an organo-silicone based surfactant.

Each embodiment disclosed herein is contemplated as being applicable to each of the other disclosed embodiments. Thus, all combinations of the various elements described herein are within the scope of the invention. In addition, the elements recited in combination and/or composition embodiments can be used in the suspension, method, use, process and package embodiments described herein and vice versa.

In addition, when lists are provided, the list is to be considered as a disclosure of any one member of the list.

This invention will be better understood by reference to the experimental details which follow, but those skilled in the art will readily appreciate that the specific experiments detailed are only illustrative of the invention as described more fully in the claims which follow thereafter. Persons skilled in these arts will appreciate that several ingredients and process conditions and equipment may be altered or replaced without departing from the invention, and further optimizations are definitely envisaged.

The invention is illustrated by the following examples without limiting it thereby.

### Example A

solid composition comprising acetamiprid and cyantraniliprole. PSD of acetamiprid is 200 micron (D₉₀) and PSD of other solids including cyantraniliprole is 25 micron (D₉₀).

The wetted solid composition before drying is shown in Table 1.

TABLE 1

| Ingredient | | % w/w |
|---|---|---|
| Acetamiprid | Insecticidal Active | 40 (39.6) |
| Cyantraniliprole | Insecticidal Active | 28 (27.7) |
| Aerosol OT-B | sodium bis(2-ethylhexyl)sulfosuccinate | 2 (1.9) |
| | (blend with sodium benzoate) | |
| Lactose | Carrier | 9 (9.4) |
| corn starch | Carrier | 4 (4.3) |
| Silfoam ® SP150 | Polydimethylsiloxane on an inorganic | 0.5 |
| | carrier (antifoam) | |
| Borrasperse CA | Lignosulphonate (Ca) | 5 (4.8) |
| Atlox Metasperse | modified styrene acrylic polymer | 5 (4.8) |
| 550 S | | |
| Silwet ® L-77 | Polyalkylene oxide Modified Heptamethyl | 0.2 |
| | tri-siloxane organo-silicone based | |
| | surfactant | |
| water | wetting liquid | 7 (6.7) |

The wetted solid composition of Table 1 was dried to prepare the water dispersible solid composition shown in Table 2.

TABLE 2
Water dispersible solid composition (after drying)

| Ingredient | | % w/w |
|---|---|---|
| Acetamiprid | Insecticidal Active | 40 (41.2) |
| Cyantraniliprole | Insecticidal Active | 29 (28.8) |
| Aerosol OT-B | sodium bis(2-ethylhexyl)sulfosuccinate | 2 |
| | (blend with sodium benzoate) | |
| Lactose | Carrier | 10 (9.8) |
| corn starch | Carrier | 5 (4.5) |
| Silfoam ® SP150 | Polydimethylsiloxane on an inorganic | 0.5 |
| | carrier | |
| Borresperse CA | lignosulphonate | 5 |
| Atlox ® | modified styrene acrylic polymer | 5 |
| Metasperse 550 S | | |
| Silwet ® L-77 | Polyalkylene oxide Modified Heptamethyl | 0.2 |
| | tri-siloxane organo-silicone based | |
| | surfactant | |
| water | Wetting liquid | 3 |

The procedure for preparing WDG (water dispersible solid composition in the form of granules) is summarized below.

Step A: preparing solid blend(s) Mixing cyantraniliprole in solid form with at least one agriculturally acceptable solid carrier, milling the mixture to prepare a blend A (20 micron).

Preparing Blend B by Milling Acetamiprid to a PSD Such that D₉₀ Value of about 200 Micron

### Preparing the Pre-Mix:

Mixing blends, A and B,

### Granulation Process:

The pre-mix was wetted with a wetting liquid comprising the organo-silicon-based surfactant
Wet granulation and drying to a Loss on Dry (LOD) of about 3%. Packaging

### Stability Tests:

### Test 1, Disintegrating Rate Measurement

In water dispersible solid compositions exemplified by WDG, disintegration/wettability may be measured as “number of inversions”. The number of inversions is a qualitative measurement of dispersibility, the lower the number of inversions the better the dispersibility.

A “wettable” water dispersible solid composition is an appropriate term when the number of inversions is lower than 30. The compositions of the invention are typically those in which 25 inversions or less, are required for complete disintegration of the solid water dispersible granule compositions of the invention, using the test outlined below. There are advantages when the composition requires less than 15 inversions for complete disintegration in water.

### Disintegration was Tested in the Following Manner:

2.5 gr of solid composition (example A) was added to 100 ml water in 250 ml cylinder.

The cylinder was then subjected to inversions (flips) (1 flip per second) repeated until all granules were disintegrated and the remaining solid material was completely suspended.

### Test 2, Dispersibility Test According to CIPAC MT 174:

9 gr solid composition (Example A) was added to 900 gr water under agitation at 300 RPM for 1 minute.

The suspension was then left for 1 minute with no agitation, followed by removing the upper 810 gr (cm³). The remaining material was dried until constant weight. The spontaneity of dispersion (dispersibility), is calculated according to the formula:

Calculate the dispersibility of the WG by the formula:

$$Dispersibility = \frac{10}{9} \cdot \frac{m - W}{m} \cdot 100 \%$$

where:
   W=mass of residue after drying (g)
   M=mass of sample taken

One measure of Good dispersibility is a product which displays or provides a value>60%.

### Test 3, Residual Solids on Wet Sieve (WSR) (CIPAC MT 185):

This test emphasizes the quality of the dispersion obtained when the composition is in water. This measures the quality by means of measuring the formation of aggregated material in the dispersion that does not pass through a sieve of 75μ. The acceptable residue is less than 2% of the material, preferably <0.2% remaining on the 75 micron sieve when the dispersion is passed through.

WSR was tested in the following manner: 10 gr of the granular composition, example A, in 100 ml tap water was stirred for 5 minutes, the slurry was then transferred through a 75μ sieve followed by rinsing the sieve with tap water until the amount of retained solids on the sieve remained constant. The residual material was then dried and weighed.

### Test 4, Suspensibility was Tested in the Following Manner: (CIPAC MT184 Method)

0.075 gr of water dispersible solid composition was added to a cylinder containing 250 ml water (342 ppm salinity), the material was dispersed by shaking up and down the cylinder 10 times.

After 30 minutes (rest), the top 90% of the suspension was evacuated/removed and the amount of material left in the bottom of the cylinder was analytically determined.

Suspensibility is calculated separately for each active ingredient according to the formula:

$$Suspensibility = \frac{10}{9} \times \frac{100 \times ( c - Q )}{c} = \frac{111 \times ( c - Q )}{c} \%$$

where:
   a=percentage by mass (% w/w) of the a.i. in the sample
   b=mass of sample added to the cylinder (g)

$$= \frac{\times b}{100} ( g )$$

c=mass (e.g. a.i's) in the whole cylinder (g)
Q mass (e.g. a.i's) of the 25 ml remaining in the cylinder (g)

Good suspensions provide values>85%, while values that exceed 105% or below 60% are considered as non-stable suspensions. Typically, values between about 60% to about 85% are considered acceptable

### Results for Example A

Example A

| | Acetamiprid | Cyantraniliprole |
|---|---|---|
| Suspensibility (before storage) | 90% | 87.5% |
| Suspensibility (After storage) | 89% | 87% |

| Dispersibility | 71.5% |
|---|---|
| Dispersibility after storage | 70.8% |
| (54° C. 2 weeks) | |
| Number of Inversions | 20 |
| WSR 75 micron | No residues |

### Example B

solid composition comprising acetamiprid and cyantraniliprole. PSD of acetamiprid is 200 micron (D₉₀) and PSD of other solids including cyantraniliprole is 25 micron (D₉₀).

The wetted solid components of the composition before drying is shown in Table 3.

TABLE 3

| Ingredient | | % w/w |
|---|---|---|
| Acetamiprid | Insecticidal Active | 40 (39.6) |
| Cyantraniliprole | Insecticidal Active | 28 (27.7) |
| Aerosol ® OT-B | sodium bis(2-ethylhexyl)sulfosuccinate/sodium benzoate | 2 (1.9) |
| Lactose | Carrier | 8 (8.4) |
| Kaolin | Carrier | 4 (4.3) |
| Silfoam ® SP150 | Polydimethylsiloxane on an inorganic carrier | 1.5 |
| Borrasperse CA | lignosulphonate | 5 (4.8) |
| Atlox Metasperse 550 S | modified styrene acrylic polymer | 5 (4.8) |
| Silwet ® L-77 | Polyalkylene oxide Modified Heptamethyl tri-siloxane | 0.4 |
| water | Wetting liquid | 7 (6.7) |

The wetted solid composition of Table 3 was dried to prepare the water dispersible solid composition shown in Table 4.

TABLE 4
Water dispersible solid composition (after drying)

| Ingredient | | % w/w |
|---|---|---|
| Acetamiprid | Insecticidal Active | 40 (41.2) |
| Cyantraniliprole | Insecticidal Active | 29 (28.8) |
| Aerosol OT-B | sodium bis(2-ethylhexyl)sulfosuccinate | 2 |
| | (blend with sodium benzoate) | |
| Lactose | Carrier | 9 (8.8) |
| Kaolin | Carrier | 5 (4.5) |
| Silfoam ® SP150 | Polydimethylsiloxane on an inorganic carrier | 1.5 |
| Borrasperse CA | lignosulphonate | 5 |
| Atlox ® Metasperse 550 S | modified styrene acrylic polymer | 5 |
| Silwet ® L-77 | Polyalkylene oxide Modified Heptamethyl tri-siloxane | 0.4 |
| | Organo-silicone based surfactant | |
| water | Wetting liquid | 3 |

The procedure for preparing WDG (water dispersible solid composition in the form of granules) is summarized below.

### Preparing Solid Blend(s):

Cyantraniliprole was mixed in solid form with at least one agriculturally acceptable solid carrier, milling the mixture to prepare a blend A (D₉₀=20 micron).

Acetamiprid was mixed in solid form with at least one agriculturally acceptable solid carrier, milling the mixture to prepare a blend B (D₉₀=200 micron).

### Preparing the Pre-Mix:

blends, A and B were mixed,

### Granulation Process:

The pre-mix was wetted with a wetting liquid comprising the organo-silicon-based surfactant and water,

Wet granulation and drying to a Loss on Dry (LOD) of 3%.

### Packaging.

### Results for Example B

Example B

| | Acetamiprid | Cyantraniliprole |
|---|---|---|
| Suspensibility (before storage) | 78.7% | 75.8% |
| Suspensibility (After storage) | 80.4% | 76.5% |

| | |
|---|---|
| Dispersibility | 73% |
| Dispersibility after storage | 68% |
| (54° C. 2 weeks) | |
| Number of Inversions | 28 |
| WSR 75 micron | 0.15% |

A series of experiments were conducted to review process parameter optimizations. Inventors have used the following three parameters that correlate to the optimized quality of Water Dispersible Granule formulations of the invention:
Number of inversions required for complete disintegration—should not exceed 25
Wet Sieve Residue (75μ)—should not exceed 2%
Persistent foaming 0.5% of solid in water D (according to CIPAC) after 1 min should not exceed 59 ml.

### Experiments Based on Varying the Process Parameters of Composition 1 [Table 2]

It was established that the properties of WDG granules according to composition 1 are sensitive to the particle sizes of each of the active ingredients and other inert additives.

### Composition 1

| Ingredient | | % w/w |
|---|---|---|
| Acetamiprid | Insecticidal Active | 40 (41.2) |
| Cyantraniliprole | Insecticidal Active | 29 (28.8) |
| Aerosol ® OT-B | sodium bis(2-ethylhexyl)sulfosuccinate | 2 |
| | (blend with sodium benzoate) | |
| Lactose | Carrier | 10 (9.8) |
| corn starch | Carrier | 5 (4.5) |
| Silfoam ® SP150 | Polydimethylsiloxane on an inorganic carrier | 0.5 |
| Borresperse CA | lignosulphonate | 5 |
| Atlox Metasperse 550 S | modified styrene acrylic polymer | 5 |
| Silwet ® L-77 | Polyalkylene oxide Modified Heptamethyl tri-siloxane | 0.2 |
| | organo-silicone based surfactant | |
| water | Wetting liquid | 3 |

### Example 1

Both acetamiprid and cyantraniliprole were milled together to PSD where D₉₀=150μ
Milling—mechanical grinding (Retsch® ZM300, 0.5 mm screen, 8000 RPM)

### Results

Granules are brittle and non-applicable as a useable granular product
WSR—2.5%—less than acceptable
Foam—70 ml—more than desired

### Example 2

Both acetamiprid and cyantraniliprole were milled together to PSD where D₉₀=150μ
Milling—airjet mill

### Results

Disintegration—35 inversions required for complete disintegration
Persistent Foam—75 ml—more than desired

### Example 3

### Milled Separately:

Acetamiprid milled separately to PSD where D₉₀=150μ (Air Jet mill)
Cyantraniliprole together with all inert solid additives (other than the organo-silicone based surfactant) milled to PSD where D₉₀=30μ
(Retch ZM300, 0.2 mm screen, 14000 rpm)

### Results

Disintegration—10 inversions required for complete disintegration—acceptable
Persistent Foam—50 ml—acceptable
Wet sieve residue (75μ)—2%—acceptable

### Example 4

Acetamiprid milled separately to 180μ (Retsch® ZM300, 0.5 mm screen, 6000 RPM)
Cyantraniliprole milled with all inert additives (other than the organo-silicone based surfactant), milled to PSD where D₉₀=30μ
(Retch ZM300, 0.2 mm screen, 15000 RPM)

### Results

Disintegration—25 inversions for complete disintegration
Foam—70 ml
Wet sieve residue (75μ)—2%

It is noted that while other parameters are acceptable, the amount of persistent foam in example 4 is higher than desired. It appears that it is better to mill the lactose together with the acetamiprid because when lactose is milled too finely it adversely affects the foaming. However, lactose should not be used unmilled altogether if it has particle sizes of 300 microns or greater, thus milling lactose together with the acetamiprid is advantageous.

The milling scenarios described above showed that for the Composition 1, in those cases in which the two pesticides were milled together the process fails to provide an acceptable granule. However, by milling the Cyantraniliprole separately to smaller particle size than the acetamiprid, an acceptable granulate can be prepared. Inventors note that different milling techniques can produce varying results depending on the milling technique but in both tested techniques the WDG can pass requirements.

### Experiments Based on Varying the Process Parameters of Composition 2

The properties of granules according to composition 2 were found to be sensitive to the particle sizes of each of the active ingredients and other inert additives.

### Composition 2:

| Ingredient | | % w/w |
|---|---|---|
| Acetamiprid | Insecticidal Active | 40 (41.2) |
| Cyantraniliprole | Insecticidal Active | 29 (28.8) |
| Aerosol OT-B | sodium bis(2-ethylhexyl)sulfosuccinate with sodium benzoate | 2 |
| Lactose | Carrier | 9 (8.6) |
| Kaolin | Carrier | 5 (4.5) |
| Silfoam ® SP150 | Polydimethylsiloxane on an inorganic carrier | 1.5 |
| Borresperse CA | lignosulphonate | 5 |
| Atlox ® Metasperse 550 S | modified styrene acrylic polymer | 5 |
| Silwet ® L-77 | polyalkylene oxide Modified Heptamethyl tri-siloxane (Organo- | 0.4 |
| | silicone based surfactant) | |
| water | Wetting liquid | 3 |

### Example 5

All solids milled together to PSD where D₉₀=200μ
(Retsch ZM300, 0.5 mm screen, 6000 rpm)

### Results

25 inversions required for complete disintegration.
Foam—10 ml
Wet Sieve Residue (75μ)—6%—unacceptably high

### Example 6

All solids milled together to PSD where D₉₀=10μ (Air jet mill)

### Results

60 inversions for complete disintegration—unacceptably high
Foam—70 ml—unacceptably high
Wet sieve residue (75μ)—9%—unacceptably high

### Example 7

Acetamiprid milled together with Borresperse CA and Metasperse 550S to PSD where D₉₀=170μ (Retsch ZM300, 0.5 mm screen, 6000 RPM)
Cyantraniliprole together with other inert additives milled to PSD where D₉₀=20μ
(Retch ZM300, 0.2 mm screen, 14000 rpm)

### Results

number of inversions for complete disintegration—16
Foam—100 ml—too high
Wet sieve residue (75μ)—0.5%

### Example 8

Cyantraniliprole mixed with all inert additives (other than the organo-silicone surfactant), milled to PSD where D₉₀=20μ (Retsch ZM300, 0.2 mm screen, 14000 RPM) then combined with acetamiprid and milled again (Retsch ZM300, 0.5 mm screen, 6000 RPM)

### Results

number of inversions for complete disintegration—20
Foam—60 ml
Wet sieve residue (75μ)—4.3%—too high

### Example 9

Acetamiprid milled with lactose to PSD where D₉₀=180μ (Retsch ZM300, 0.5 mm screen, 6000 RPM)
Cyantraniliprole with the rest of inert additives except organo-silicone surfactant, milled to PSD where D₉₀=25μ (Retch ZM300, 0.2 mm screen, 14000 RPM)

### Results

number of inversions for complete disintegration—20
Foam—30 ml
Wet sieve residue (75μ)—0.1%

The milling scenarios described above show that for the composition (2), those processes in which the two pesticides are milled together fails to provide an acceptable granule. Comparing example 7 to example 9 suggests that milling lactose to fine particles affects the foaming of the resulting granules. However, milling the acetamiprid together lactose to a PSD where D₉₀ is between about 150μ to about 200 microns such as about 170μ and the remaining solid ingredients to PSD where D₉₀=about 25μ is a process that provides quality optimization.

1. A solid composition comprising acetamiprid, cyantraniliprole, surfactant and/or dispersant, agriculturally acceptable carrier, and water.

2. A solid composition comprising acetamiprid, particulate cyantraniliprole, surfactant and/or dispersant, agriculturally acceptable solid carrier, and water.

3. A solid composition comprising acetamiprid, particulate cyantraniliprole, surfactant and/or dispersant, agriculturally acceptable solid carrier, and water, wherein the percentage of water contained in the composition is between about 5% w/w and about 0.5% w/w, such as about 3% w/w, based on the total weight of the composition.

4. A packaged solid composition comprising acetamiprid, particulate cyantraniliprole, surfactant and/or dispersant, agriculturally acceptable solid carrier, and water, wherein the percentage of water contained in the composition is between about 5% w/w and about 0.5% w/w such as about 3% w/w, based on the total weight of the composition.

5. A solid composition comprising acetamiprid, particulate cyantraniliprole, surfactant and/or dispersant, agriculturally acceptable solid carrier, and water, wherein the percentage of water contained in the composition is between about 5% w/w and about 0.5% w/w such as about 3% w/w, based on the total weight of the composition, wherein the particle size distribution of the particulate cyantraniliprole is such that the D₉₀ value of cyantraniliprole particles is between about 10 to about 45 microns, such as between about 20 microns and about 40 microns.

6. A solid water dispersible composition in packaged granular form, comprising acetamiprid, particulate cyantraniliprole, surfactant and/or dispersant, agriculturally acceptable solid carrier, and water, wherein the percentage of water contained in the composition is between about 5% w/w and about 0.5% w/w such as about 3% w/w, based on the total weight of the composition, wherein the particle size distribution of the particulate cyantraniliprole is such that the D₉₀ value of cyantraniliprole is between about 10 to about 45 microns, such as between about 20 microns and about 40 microns.

7. A solid composition comprising particulate acetamiprid, particulate cyantraniliprole, surfactant and/or dispersant, agriculturally acceptable solid carrier, and water, wherein the percentage of water contained in the composition is between about 5% w/w and 0.5% such as about 3% w/w, based on the total weight of the composition, wherein the particle size distribution of the particulate acetamiprid is such that the D₉₀ value of acetamiprid is between about 80 to about 250 microns, such as between about 150 microns and about 200 microns.

8. A solid composition comprising particulate acetamiprid, particulate cyantraniliprole, surfactant and/or dispersant, agriculturally acceptable solid carrier, and water, wherein the percentage of water contained in the composition is between about 5% w/w and 0.5% such as about 3% w/w, based on the total weight of the composition, wherein the particle size distribution of the particulate cyantraniliprole is such that the D₉₀ value of cyantraniliprole particles is between about 10 to about 45 microns, such as between about 20 microns and about 40 microns and the particle size distribution of the particulate acetamiprid is such that the D₉₀ value of acetamiprid is between about 80 to about 250 microns, such as between about 150 microns and about 200 microns.

9. A solid water dispersible composition in packaged granular form, comprising particulate acetamiprid, particulate cyantraniliprole, surfactant and/or dispersant, agriculturally acceptable solid carrier, and water, wherein the percentage of water contained in the composition is between about 5% w/w and 0.5% such as about 3% w/w, based on the total weight of the composition, wherein the particle size distribution of the particulate cyantraniliprole is such that the D₉₀ value of cyantraniliprole particles is between about 10 to about 45 microns, such as between about 20 microns and about 40 microns and the particle size distribution of the particulate acetamiprid is such that the D₉₀ value of acetamiprid is between about 80 to about 250 microns, such as between about 150 microns and about 200 microns, and wherein the particulate acetamiprid is in solid intimate association with the solid carrier, selected from lactose starch and kaolin and combinations thereof.

10. A solid water dispersible composition in packaged granular form, comprising particulate acetamiprid, particulate cyantraniliprole, surfactant such as organo-silicone surfactant, solid agriculturally acceptable additive ingredient, agriculturally acceptable solid carrier, and water, wherein the percentage of water contained in the composition is between about 5% w/w and 0.5% such as about 3% w/w, based on the total weight of the composition, wherein the particle size distribution of the particulate cyantraniliprole is such that the D₉₀ value of cyantraniliprole particles is between about 10 to about 45 microns, such as between about 20 microns and about 40 microns and the particle size distribution of the particulate acetamiprid is such that the D₉₀ value of acetamiprid is between about 80 to about 250 microns, such as between about 150 microns and about 200 microns, and wherein the particulate cyantraniliprole is in solid intimate association with the solid agriculturally acceptable additive ingredient, selected from dispersing agent/dispersant; wetting agent; filler; binder; disintegration agent; anti-foaming agent; biocide; water absorbent; water scavenger; UV light protectant; antioxidant; agricultural adjuvant; and combinations of two or more thereof.

11. A solid water dispersible granule composition comprising, particulate acetamiprid, particulate cyantraniliprole, surfactant and/or wetting agent, solid agriculturally acceptable additive ingredient, agriculturally acceptable solid carrier, and water, wherein the particulate cyantraniliprole is in solid intimate association with the solid agriculturally acceptable additive ingredient, the particulate acetamiprid is in solid intimate association with the solid carrier and the water and a surfactant are both in liquid-solid intimate association with the particulate cyantraniliprole and the particulate acetamiprid.

12. The composition as claimed in any one of claims 1 to 11 comprising particulate acetamiprid in amount of between about 35% and about 45% w/w such as about 40%, particulate cyantraniliprole in amount of between about 25% and about 35% w/w such as about 30%, based on the total weight of the composition.

13. The composition as claimed in any one of claims 1 to 11 comprising particulate acetamiprid, particulate cyantraniliprole and Non-Pesticidal Ingredients (excipients), wherein, the weight ratio of the acetamiprid to the cyantraniliprole in the solid composition is between 1:5 to 5:1, such as from about 2:1 to about 1:2.

14. The solid water dispersible granule composition as claimed in claim 11 comprising, between about 25% and 35% w/w particulate cyantraniliprole between about 35% to about 45% w/w particulate acetamiprid, between about 0.1% to about 2% w/w organo-silicone surfactant in aqueous solution and between about 0.01% to about 10% w/w of a solid surfactant/wetting agent selected from alkyl naphthalene sulfonate salt, phenyl sulfonic acid (such as sodium salt), alcohol ethoxylate, sodium lauryl sulfate, polyalkoxylated butyl ether, poly aryl phenyl phosphate ether, docusate sodium, wherein the organo-silicone surfactant is in liquid-solid intimate association with the particulate cyantraniliprole and the particulate acetamiprid and the particulate cyantraniliprole is in solid intimate association with the solid surfactant/wetting agent.

15. The solid water dispersible granule composition as claimed in claim 14 wherein the particulate cyantraniliprole is characterized by a particle size distribution such that the D₉₀ value of the particles is between about 10 to about 45 microns such as between about 20 to about 40 microns, the particulate acetamiprid is characterized by a particle size distribution such that the D₉₀ value of the particles is between about 80 microns and 250 microns, such as between about 150 microns and about 200 microns.

16. The solid water dispersible granule composition as claimed in any one of claims 11-15 wherein the composition is a dried granule comprising between about 3% w/w and about 0.5% of water based on the total weight of the composition, wherein the composition is packaged in protective packaging or container system characterized by either or both,
a. being sufficiently impermeable to moisture, being constructed from materials and closure means, that are sufficiently impermeable to the ingress of moisture such that the contained solid water dispersible granule composition maintains a water (moisture) content of between about 5% and about 0.5%, over a storage period, such as the shelf life of the composition at ambient conditions or storage periods at elevated temperatures and/or elevated relative humidity; and
b. being constructed such that they provide protection from UV light within the wavelengths range of about 100-400 nm such that the material of the package, container system or a coating over the package is sufficiently opaque to UV light that the undegraded content of acetamiprid and/or the undegraded cyantraniliprole content in the package over a storage period is no less than about 90% of the content measured prior to packaging the dried, solid composition.

17. A solid composition comprising (1) an amount of acetamiprid, (2) an amount of cyantraniliprole and (3) agriculturally acceptable solid carrier.

18. A solid composition comprising (1) an amount of acetamiprid, (2) an amount of cyantraniliprole and (3) agriculturally acceptable solid carrier wherein after dispersion in, or dilution with an aqueous media such as water, the cyantraniliprole is suspended in the aqueous media or water as dispersed solid particles and the acetamiprid is dissolved in the aqueous media (water).

19. The composition of claim 17 or 18, wherein the composition is a water dispersible solid composition.

20. The composition of claim 17 or 18, wherein the composition is in the form of wettable dispersible granules.

21. The composition of claim 17 or 18, wherein the solid composition is in the form of granules.

22. The composition of any one of claims 17-21, wherein the amount of acetamiprid in the composition is between about 1% to about 90% w/w based on the total weight of the composition.

23. The composition of claim 22, wherein the amount of acetamiprid in the composition is between about 35% to about 45% w/w based on the total weight of the composition.

24. The composition of claim 23, wherein the amount of acetamiprid in the composition is about 40% w/w, such as between 39.6 and 41.2% w/w based on the total weight of the composition, wherein about is quantified as ±10% of the value.

25. The composition of any one of claims 17-21, wherein the amount of cyantraniliprole in the composition is between about 1% to about 90% w/w based on the total weight of the composition.

26. The composition of claim 25, wherein the amount of cyantraniliprole in the composition is between about 25% to about 35% w/w based on the total weight of the composition.

27. The composition of claim 26, wherein the amount of cyantraniliprole in the composition is about 30% w/w, such as between about 27.7% and about 28.8% w/w based on the total weight of the composition, wherein about is quantified as ±10% of the value.

28. The composition of any one of claims 17-21, wherein the weight ratio of the acetamiprid to the cyantraniliprole in the solid composition is between about 1:5 to 5:1.

29. The composition of claim 28, wherein the weight ratio of the acetamiprid to cyantraniliprole in the solid composition is about 1.4:1, such as about 1.43:1.

30. The composition of any one of claims 17-29, wherein the composition comprises solid particles characterized by a particle size distribution such that the D₉₀ value is between about 4 and about 200 microns.

31. The composition of any one of claims 17-29, wherein the composition comprises solid particles of acetamiprid characterized by a particle size distribution such that the D₉₀ value is between about 80 microns and 250 microns, such as between about 150 microns and about 200 microns wherein about is quantified as ±10% of the value.

32. The composition of any one of claims 17-29, wherein the composition comprises solid particles of cyantraniliprole characterized by a particle size distribution such that the D₉₀ value is between about 10 microns and 45 microns such as between about 20 microns and about 40 microns wherein about is quantified as ±10% of the value.

33. A water dispersible solid composition comprising:
a. acetamiprid in amount of about 35-45% w/w based on the total weight of the composition,
b. cyantraniliprole in amount of about 25-35% w/w based on the total weight of the composition.
c. dispersant in amount of about 5% to about 15% w/w such as about 10% w/w, based on the total weight of the composition, wherein the dispersant is selected from hydrophobically modified polyacrylate such as modified styrene acrylic polymer, a copolymer of AMPS and ethyl acrylate, alkyl naphthalene sulfonate formaldehyde condensate, polycarboxylate (such as di-iso butylene maleic acid co-polymer, sodium salt), lignosulfonates and combinations thereof.

34. A water dispersible solid composition comprising:
(a) acetamiprid in amount of about 40% w/w such as between about 39.6 and about 41.2% w/w, based on the total weight of the composition and
(b) cyantraniliprole in amount of about 30% w/w such as between about 27.7% and about 28.8% w/w, based on the total weight of the composition,
wherein about, is ±10% of the value.

35. The composition of any one of claims 17-34, wherein the composition comprises organo-silicone based surfactant.

36. The composition of claim 35, wherein the weight ratio between the cyantraniliprole and the organo-silicone based surfactant in the composition is between about 200:1 to about 20:1.

37. The composition of any one of claims 17-34, wherein the composition is diluted with water and combined with organo-silicone based surfactant in a tank mix.

38. The composition of any one of claims 35-37, wherein the organo-silicone based surfactant is any some or all of, a polyether tri-siloxane, a tri-siloxane alkoxylate, a polyalkylene oxide modified heptamethyl tri siloxane, ethoxylated propoxylated siloxanes and silicones.

39. The composition of any one of claims 17-38, wherein the composition comprises an agriculturally acceptable additive.

40. The composition of claim 39, wherein the agriculturally acceptable additive is selected from the group of dispersing agent, wetting agent other than organo-silicone surfactant, organo-silicone surfactant, filler, binder, disintegration agent, anti-foaming agent, biocides, water absorbents, water scavengers, adjuvants and any combination thereof.

41. A combination of,
a. a water dispersible solid composition comprising
i. particulate acetamiprid,
ii. particulate cyantraniliprole and
iii. agriculturally acceptable solid carrier,
b. organo-silicone based surfactant, and
c. water.

42. The combination of claim 41, wherein the weight ratio between the cyantraniliprole and the organo-silicone based surfactant in the combination is between 150:1 to 35:1.

43. The combination of claim 40 or 41, wherein the organo-silicone based surfactant is any, some, or all of, a polyether tri-siloxane, a tri-siloxane alkoxylate, a polyalkylene oxide modified heptamethyl tri siloxane, ethoxylated propoxylated siloxanes and silicones.

44. A method for preparing a packaged solid water dispersible granular composition of acetamiprid and cyantraniliprole characterized by improved wettability and suspensibility comprising,
a. reducing the particle size, of an blend of solid particulate acetamiprid and lactose to D₉₀ of between about 150 microns to about 200 microns, to obtain a milled acetamiprid blend,
b. separately reducing the particle size of an blend of solid particulate cyantraniliprole, dispersant, carrier particles and wetting agent, to D₉₀ of about 20 microns to about 40 microns to obtain a milled cyantraniliprole blend,
c. wet granulating a combination of milled acetamiprid blend and milled cyantraniliprole blend with an organo-silicone based surfactant in water to obtain a wet granulate,
d. drying the wet granulate until the water content is between about 3% and about 0.5% to obtain a dry water dispersible granule composition, and
e. packaging the dry water dispersible granule composition in packaging together with directions for diluting and dispersing the dry water dispersible granule composition in sufficient water to obtain an improved suspension of solid particles of cyantraniliprole in an aqueous solution of acetamiprid,
thus, obtaining the improved solid water dispersible granular composition comprising acetamiprid and cyantraniliprole characterized by spontaneity of dispersion, low foaming and minimal agglomerate formation and/or undue particle size growth when diluted in water.

45. The method of claim 44, wherein the carrier particles are either or both, starch and kaolin, and the wetting agent is selected from alkyl naphthalene sulfonate salt; phenyl sulfonic acid (such as sodium salt); alcohol ethoxylate; sodium lauryl sulfate; polyalkoxylated alkyl ether such as polyalkoxylated butyl ether; poly aryl phenyl phosphate ether, docusate sodium and combinations thereof.

46. The method of either claim 44 or 45, wherein the dispersant is selected from condensate of alkyl naphthalene sulfonate formaldehyde, alkoxylated alcohol, alkyl naphthalene sulfonate condensate sodium salt, ethoxylated fatty alcohol, hydrophobically modified polyacrylate such as modified styrene acrylic polymer, polycarboxylate (such as di-iso butylene maleic acid co-polymer, sodium salt), lignosulfonates, polyelectrolyte block copolymer such as AMPS-ethyl acrylate co-polymer, alkyl sulfonates, alkyl benzene sulfonates, alky lauryl sulfonates, alkyl phenol alkoxylates, tri styryl phenol ethoxylates, synthetic or natural fatty ethoxylates alcohols synthetic or natural fatty, block copolymers such as ethylene oxide-propylene oxide block copolymers and ethylene oxide-butylene oxide block copolymers, synthetic or natural fatty alcohol alkoxylates, alkoxylated alcohols such as poly glycol ether of n-butyl alcohol, polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or poly-oxy alkylene, quaternary ammonium compounds and fatty amine salts, salts of alkyl aryl sulfonic acids, salts or sulfated polyglycol ethers, salts of phosphated polyglycol ether; and any combination thereof.

47. A method for preparing an improved suspension of solid particles of cyantraniliprole in an aqueous solution of acetamiprid comprising, removing a solid water dispersible granule composition from its packaging, and diluting and dispersing the granule composition in water according to the directions packaged with the granule composition, wherein the packaged solid water dispersible granule composition comprises
a. a blend of solid particulate acetamiprid and lactose milled to D₉₀ of between about 150 microns to about 200 microns,
b. a blend of solid particulate cyantraniliprole, dispersant, carrier particles and wetting agent, milled to D₉₀ of about 20 microns to about 40 microns,
c. and an organo-silicone based surfactant, and
d. between about 3% and about 0.5% water content
to obtain an improved suspension of solid particles of cyantraniliprole in an aqueous solution of acetamiprid wherein the improvement is characterized by dispersion stability and by less than about 2% agglomerate formation and/or undue particle size growth, as measured by wet sieve residue after passing the suspension through a 75 micron sieve.

48. The method of claim 47, wherein the carrier particles are either or both, starch and kaolin, the wetting agent is selected from alkyl naphthalene sulfonate salt; phenyl sulfonic acid (such as sodium salt); alcohol ethoxylate; sodium lauryl sulfate; polyalkoxylated alkyl ether such as polyalkoxylated butyl ether; poly aryl phenyl phosphate ether, docusate sodium and combinations thereof.

49. The method of either claim 47 or 48, wherein the dispersant is selected from condensate of alkyl naphthalene sulfonate formaldehyde, alkoxylated alcohol, alkyl naphthalene sulfonate condensate sodium salt, ethoxylated fatty alcohol, hydrophobically modified polyacrylate such as modified styrene acrylic polymer, polycarboxylate (such as di-iso butylene maleic acid co-polymer, sodium salt), lignosulfonates, polyelectrolyte block copolymer such as AMPS-ethyl acrylate co-polymer, alkyl sulfonates, alkyl benzene sulfonates, alky lauryl sulfonates, alkyl phenol alkoxylates, tri styryl phenol ethoxylates, synthetic or natural fatty ethoxylates alcohols synthetic or natural fatty, block copolymers such as ethylene oxide-propylene oxide block copolymers and ethylene oxide-butylene oxide block copolymers, synthetic or natural fatty alcohol alkoxylates, alkoxylated alcohols such as poly glycol ether of n-butyl alcohol, polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or poly-oxy alkylene, quaternary ammonium compounds and fatty amine salts, salts of alkyl aryl sulfonic acids, salts or sulfated polyglycol ethers, salts of phosphated polyglycol ether; and any combination thereof, such as a combination of lignosulfonates and a polyelectrolyte block copolymer such as modified styrene acrylic polymer, and/or AMPS-ethyl acrylate co-polymer.

50. An improved water diluted composition comprising suspended solid particles of cyantraniliprole in an aqueous solution of acetamiprid wherein the water diluted composition is prepared by dispersing a water dispersible solid granular composition of solid particulate acetamiprid and solid particulate cyantraniliprole, in water or aqueous media characterized in minimal formation of agglomerates and/or particle size growth, wherein the improvement is such that the residue remaining on a 75 micron screen when the diluted composition is passed therethrough is less than 2%.

51. A solid composition comprising both solid particulate acetamiprid and solid particulate cyantraniliprole each characterized by a distinct particle size distribution (PSD), such that the ratio between the D₉₀ values characterizing the cyantraniliprole PSD and the acetamiprid PSD is between 1:1.5 and 1:20 and the D₉₀ value characterizing the acetamiprid particle size distribution (PSD), is at least 50 microns greater than the D₉₀ value characterizing the particulate cyantraniliprole, wherein the D₉₀ value characterizing the acetamiprid particle size distribution is about 80 microns or more.

52. A solid composition comprising both solid particulate acetamiprid and solid particulate cyantraniliprole each characterized by a distinct particle size distribution (PSD), such that the ratio between the D₉₀ values characterizing the cyantraniliprole PSD and the acetamiprid PSD is between 1:1.5 and 1:20 and the D₉₀ value characterizing the acetamiprid particle size distribution (PSD), is at least 50 microns greater than the D₉₀ value characterizing the particulate cyantraniliprole, wherein the D₉₀ value characterizing the cyantraniliprole particle size distribution is about 45 microns or less.

53. A composition comprising a dispersion of solid particulate cyantraniliprole, suspended in a solution of acetamiprid in water wherein the composition is obtained by diluting and/or dispersing the solid composition as claimed in claim 51 in an aqueous medium such as water, wherein the composition comprising a dispersion is characterized by a suspended particle size distribution such that the D₉₈ value is about 75 microns or less as measured by a wet screen retention test through a 75 micron sieve, wherein the D₉₀ value characterizing the cyantraniliprole particle size distribution in the solid composition is about 45 microns or less prior to dilution and/or dispersion.

54. A composition comprising a dispersion of solid particulate cyantraniliprole, suspended in a solution of acetamiprid in water obtained by diluting and/or dispersing the solid composition as claimed in claim 51 in an aqueous medium such as water, characterized by a suspended particle size distribution such that the D₉₈ value is about 75 microns or less as measured by a wet screen retention test through a 75 micron sieve, wherein the composition wherein the D₉₀ value characterizing the cyantraniliprole particle size distribution in the solid composition is about 40 microns or less and the D₉₀ value characterizing the solid acetamiprid particle size distribution in the solid composition is between about 150 microns and about 200 microns.

55. The composition comprising a dispersion of any one of claims 53 and 54, wherein the D₉₀ value characterizing the cyantraniliprole particle size distribution in the solid composition is about 20 microns or more.

56. The solid composition of claim 51, wherein the ratio between the D₉₀ values characterizing the cyantraniliprole PSD and the acetamiprid PSD is selected from the group of,
a. between about 1:2 to about 1:10;
b. between about 1:2.5 to about 1:5; and
c. between about 1:3 to 1:4,
and the D₉₀ value characterizing the cyantraniliprole particle size distribution is about 20 microns or more.

57. A solid water dispersible granule composition comprising,
particulate acetamiprid, D₉₀ about 150μ about 200μ, about 35-45% w/w,
particulate cyantraniliprole D₉₀ about 20μ about 40μ, about 25-35% w/w, docusate sodium,
lactose,
corn starch or kaolin,
antifoam,
lignosulphonate (Ca),
modified styrene acrylic polymer,
organo-silicone based surfactant, and
water about 3%-0.5% w/w,
wherein the particulate acetamiprid is in intimate solid association with the lactose, wherein the particulate cyantraniliprole is in intimate solid association with the corn starch or kaolin, the antifoam, the lignosulphonate and the modified styrene acrylic polymer, and the organo-silicone based surfactant and the water are in liquid-solid intimate association with the particulate cyantraniliprole and the particulate acetamiprid.

58. A suspension comprising a dispersion of solid particulate cyantraniliprole, suspended in a solution of acetamiprid in water, and surfactant and/or dispersant, and agriculturally acceptable carrier, wherein the composition is obtained by diluting and/or dispersing the solid composition as claimed in any one of claims 1-11, 17-36, 51-52 and 57, in an aqueous medium such as water.

59. A method for controlling unwanted insects comprising applying an effective amount of any one of the combination and composition of any one of claims 17-43, to a plant, a locus thereof, propagation material thereof, a structure, wood, or an area infested with the unwanted insects so as to thereby control the unwanted insects.

60. A process for preparing a water dispersible solid composition comprising solid acetamiprid and solid cyantraniliprole, and solid non-pesticidal ingredients (excipients), the process comprising (1) preparing a pre-mix of all the solid components, (2) wetting the pre-mix of step (1) with a wetting liquid, (4) performing wet granulation and drying.

61. The process of claim 60, wherein the pre-mix is a mixture of two solid blends.

62. The process of claim 60, wherein the pre-mix is mixture of solid blends wherein each solid blend is characterized by a different distribution of particle sizes.

63. The process of claim 60, wherein solid non-pesticidal ingredient (excipient) comprise one or more agriculturally acceptable additives selected from the group of
a. dispersing agent/dispersant;
b. wetting agent,
c. filler,
d. binder,
e. disintegration agent,
f. anti-foaming agent,
g. biocide,
h. water absorbents,
i. water scavengers,
j. UV light protectant;
k. antioxidant;
l. agricultural adjuvant; and
m. combinations of two or more thereof.

64. A process for preparing a packaged water dispersible solid composition in granular form, comprising acetamiprid, cyantraniliprole, and solid excipients components the process comprising
a. obtaining particulate acetamiprid with a defined particle size distribution such that D₉₀ is between about 80 microns and 250 microns,
b. obtaining particulate cyantraniliprole with a different defined particle size distribution, such that D₉₀ is between about 10 microns and 45 microns
c. combining the particulate acetamiprid, the particulate cyantraniliprole, and solid excipients components to obtain a pre-mix of all the solid components,
d. wetting the obtained pre-mix of step with an aqueous wetting liquid,
e. wet granulating, to obtain wet granules
f. drying to obtain a dry granulate characterized by a moisture content of about 3% or less (LOD), and
g. packaging the dry granulate into suitable container systems or packages,
wherein the suitable packaging or container system is constructed from materials and closure means, that are sufficiently impermeable to the ingress of moisture such that the contained water dispersible solid composition maintains a water (moisture) content of about 5% or less, such as between about 3% and about 0.5%, over a storage period, such as over the shelf life of the composition at ambient conditions or over two weeks at accelerated storage conditions defined by elevated temperatures and relative humidity.

65. The process for preparing a packaged water dispersible solid composition in granular form, of claim 64 wherein the particulate acetamiprid is obtained by separately milling solid acetamiprid with lactose to a particle size distribution such that D₉₀ is between about 150 microns and 200 microns, wherein the particulate cyantraniliprole is obtained by separately milling solid cyantraniliprole together with lignosulphonate and/or modified styrene acrylic polymer, to a particle size distribution such that D₉₀ is between about 20 microns and about 40 microns, and the wetting liquid comprises water and polyalkylene oxide modified heptamethyl tri-siloxane.

66. An insecticidal tank-mix comprising the composition as claimed in any one of claims 1-11, 17-36, 51-52 and 57, diluted with water in a tank wherein the diluted concentration of acetamiprid and cyantraniliprole in the tank-mix is selected from the group of,
a. from about 100 ppm to about 1000 ppm;
b. from about 100 ppm to about 500 ppm;
c. from about 200 ppm to about 400 ppm;
d. from about 200 ppm to about 500 ppm; and
e. about 200 ppm.

67. A method for controlling unwanted insects comprising,
a. diluting the solid composition as claimed in any one of claims 1-11, 17-36, 51-52 and 57 with water in a tank to provide a tank-mix with a diluted concentration of acetamiprid and cyantraniliprole selected from the group of,
i. from about 100 ppm to about 1000 ppm;
ii. from about 100 ppm to about 500 ppm;
iii. from about 200 ppm to about 400 ppm;
iv. from about 200 ppm to about 500 ppm; and
v. about 200 ppm, and
b. applying an effective amount of the tank mix to a plant, a locus thereof, propagation material thereof, a structure, wood, or an area infested with the unwanted insects,
so as to thereby control the unwanted insects.
